(19) United States
(12) Patent Application Publication
(10) Pub. No.: US 2023/0142923 A1
(43) Pub. Date: May 11, 2023

(54) SYSTEMS AND METHODS FOR A CONTROL STATION

(71) Applicant: Oqab Dietrich Induction Inc., Kitchener (CA)

(72) Inventors: Haroon B. Oqab, Kitchener (CA); George B. Dietrich, Kitchener (CA); Joon Chung, Kitchener (CA); Mohsen Rostami, Kitchener (CA)

(21) Appl. No.: 17/918,234

(22) PCT Filed: Apr. 12, 2021
(86) PCT No.: PCT/CA2021/050488

§ 371 Date: Oct. 11, 2022

Related U.S. Application Data
(60) Provisional application No. 63/008,014, filed on Apr. 10, 2020.

(51) Int. Cl. G05D 1/00; G09B 9/30; B64U 70/40; B64U 70/80; B25J 9/16

(52) U.S. Cl. CPC G05D 1/0038; G05D 1/0044; G09B 9/301; B64U 70/40; B64U 70/80; G05D 1/0027; B25J 9/1612; G05D 1/005; B64U 2201/10

(57) ABSTRACT

A system and method for remote control of a mobile device is provided herein. The system includes a primary receiver for providing primary command and control of the mobile device; a secondary receiver for providing secondary command and control of the mobile device; the mobile device configured to respond to command and control signals sent by any of the primary receiver and the secondary receiver; and a relay platform for relaying the command and control signals throughout the system. The primary receiver may include an extended reality component.

### TECHNICAL FIELD

The embodiments disclosed herein relate to ground control stations, and, in particular to systems and methods for a ground control station that may be used to facilitate remote control of mobile devices and pilot training.

The embodiments herein further relate to development of an enhanced ground control station equipped with an advanced stand-alone virtual reality headset for remotely operating a mobile device.

Unmanned aerial vehicles (UAVs) with autonomous flight missions provide a facility for the human control of aerial vehicles. However, human operators may experience difficulty controlling remote vehicles when the vehicles operate at a distance greater than the human operator may observe (‘Beyond Visual Line of Sight’, or BVLOS).

The human operators, or pilots, may require extensive training in order to successfully operate UAVs with autonomous flight missions. However, it may be impractical to allow actual UAVs to be used to train pilots. Such training risks damage to the UAV or other property. Such training may further consume resources (such as time on the UAV), decreasing efficiency and profitability of UAV operations.

Accordingly, systems, methods, and devices to facilitate remote operation of a mobile device and remote training thereon, particularly for long range applications where Beyond Visual Line of Sight (BVLOS) operations are of interest, are desired.

### SUMMARY

An object of the present invention is to provide systems, methods, and devices for a control station for facilitating remote control of mobile devices, pilot training, and power and data transfer.

A system for remote control of a mobile device is provided. The system includes a primary receiver for providing primary command and control of the mobile device, a secondary receiver for providing secondary command and control of the mobile device, the mobile device configured to respond to command and control signals sent by any of the primary receiver and the secondary receiver, and a relay platform for relaying the command and control signals throughout the system.

The primary receiver may include a training module for training using actual fight data and simulated flight data fed through the primary receiver.

The mobile device may be any one of a vehicle, a robot, a land vehicle, a car, a truck, a water vehicle, a boat, a submarine, an air vehicle, an airplane, an airship, a helicopter, a drone, a space vehicle, a satellite, and a rocket or the like.

The air vehicle may perform take-off and landing autonomously.

The mobile device may include a computer-readable storage medium storing and processing computer vision method algorithms for detecting obstacles and objects.

The computer vision method algorithms may comprise machine learning and artificial intelligence techniques.

The primary receiver may include an extended reality headset.

The mobile device may be configured to provide data and camera feed to the extended reality headset.

The secondary receiver may include haptic controls.

The secondary receiver may be a glove.

The relay platform may include a camera.

The relay platform may be a high-altitude relay platform stationed above Earth.

The mobile device may include a robotic arm suitable for grasping, manipulating, and moving objects and the like.

The system for remote control of the mobile device may further include a fleet tracking architecture component for determining where the mobile device is in relation to other mobile devices.

The system for remote control of the mobile device may further include an autonomous virtual air traffic control and management system through the fleet tracking architecture component.

The system for remote control of the mobile device may further include a second mobile device. The mobile device and the second mobile device may be in communication with each other. The mobile device and the second mobile device may each be in communication with the relay platform and the primary and secondary receivers.

The system for remote control of the mobile device may further include an alert-based subsystem.

The system for remote control of the mobile device may further include a sensor-based subsystem for incorporating any of high-resolution cameras, pressure sensors, lidar, mechanical, and thermal systems.

The primary and secondary receivers may each be configured to switch from providing command and control of the mobile device to providing command and control of a second mobile device.

The system for remote control of the mobile device may further include a data collection subsystem for collecting data, a distributed data processing pipeline for analyzing the data, and a visualization subsystem for data management and pilot training.

The mobile device and the second mobile device may be nodes in a network, and the relay platform and the primary and secondary receivers may act as central sources in the network.

The nodes may be arranged about the central sources in any one or more of a star configuration, a mesh configuration, a ring configuration, a tree configuration, a fully connected configuration, a bus configuration about a central bus, a line configuration, an extended star configuration, a hierarchical configuration, and a non-structured configuration.

A method for remote control of a mobile device is provided. The method includes generating primary command and control signals at a primary receiver, generating secondary command and control signals at a secondary receiver for supplementing the primary command and control signals, relaying the primary and secondary command and control signals through a relay platform to the mobile device, receiving the primary and secondary command and control signals at the mobile device, and operating the mobile device remotely according to the primary and secondary command and control signals.

The primary receiver may include a training module for training using actual fight data and simulated flight data fed through the primary receiver.

The mobile device may be any one of a vehicle, a robot, a land vehicle, a car, a truck, a water vehicle, a boat, a submarine, an air vehicle, an airplane, an airship, a helicopter, a drone, a space vehicle, a satellite, and a rocket or the like.

The mobile device may include a computer-readable storage medium storing and processing computer vision method algorithms for detecting obstacles and objects.

The computer vision method algorithms may include machine learning and artificial intelligence techniques.

The primary receiver may include an extended reality headset.

The method for remote control of the mobile device may further include providing data and camera feed from the mobile device to the extended reality headset.

The secondary receiver may include haptic controls.

The relay platform may be a high-altitude relay platform stationed above Earth.

The mobile device may include a robotic arm suitable for grasping, manipulating, and moving objects and the like.

The method for remote control of the mobile device may further include performing the relaying, receiving, and operating steps for at least one additional mobile device.

The method for remote control of the mobile device may further include switching, by the primary and secondary receivers, from providing command and control of the mobile device to providing command and control of a second mobile device.

The relay platform may operate at an altitude from 3 kilometres to 22 kilometres.

The method for remote control of the mobile device may further include collecting data via a data collection subsystem, analyzing the data via a distributed data processing pipeline, and providing data management and pilot training through a visualization subsystem.

The method for remote control of the mobile device may further include collecting and transmitting the data by the mobile device.

The ground control station (GCS) including hardware and software is an important part of unmanned aerial vehicles (UAVs) with autonomous flight missions which provides the facility for the human control of aerial vehicles. The enhanced ground control station (GCS) equipped with an Advanced Stand-AIone Virtual Reality Head Mounted Display (ASVR-HMD) may advantageously facilitate remote operation of a mobile device, particularly for long range applications where Beyond Visual Line of Sight (BVLOS) operations are of interest. Such an advanced portable system is important to lower pilot workload and increase situational awareness.

Other aspects and features may become apparent, to those ordinarily skilled in the art, upon review of the following description of some exemplary embodiments.

### BRIEF DESCRIPTION OF THE DRAWINGS

The drawings included herewith are for illustrating various examples of systems, methods, articles, apparatuses, and devices of the present specifications. In the drawings:

FIG. 1 is a schematic diagram of a system for a remote control station, according to an embodiment;

FIG. 2 is a simplified block diagram of components of a computing device of FIG. 1;

FIG. 3 is a schematic diagram of a generalized system for remote operation through transmission and reception of command and control signals and operator/machine feedback information and sensor information, according to an embodiment;

FIG. 4 is an perspective view of a user device for use in the generalized system for remote operation of FIG. 3, according to an embodiment;

FIG. 5 is a flow diagram of a method for using a remote control station to interact with a remote environment, according to an embodiment;

FIG. 6 is a flow diagram of a method for using a remote control station to operate a mobile device remotely, according to an embodiment;

FIG. 7 is a schematic representation of various possible network node configurations, according to embodiments;

FIG. 8 is a schematic representation of multiple airship configurations suitable for use as a mobile device of the system for a remote control station of FIG. 1, according to embodiments;

FIG. 9 is a block diagram of a computer system for supporting real-time operations of the system of FIG. 1, according to an embodiment;

FIG. 10 is a schematic diagram of deployment of an airborne vehicle fleet of the computer system of FIG. 9, according to embodiments;

FIG. 11 is a schematic diagram of different flight patterns of the airborne vehicle fleet of the computer system of FIG. 9 in collecting data, according to embodiments;

FIG. 12 is a block diagram of a space relay and servicing system for facilitating data collection and mobile fleet use in outer space, according to an embodiment, according to an embodiment;

FIG. 13 is a view of a system for remote control of mobile devices in operation, according to an embodiment;

FIG. 14 is a view of a hybrid deployment system and method for a control station, according to an embodiment;

FIG. 15 is a conceptual view of different 3D input device applications of the haptic control of a secondary receiver of FIG. 1, according to embodiments;

FIG. 16 is a view of spheres of operation of the drones of FIG. 10, according to an embodiment;

FIG. 17 is a schematic view of a multi-domain command and control system for fleets of mobile and fixed nodes, such as the drones of FIG. 10, to perform autonomous and/or semi-autonomous operations, according to an embodiment;

FIG. 18 is a schematic representation of a system for in-orbit assembly of mobile devices, such as the mobile devices of FIG. 1, according to an embodiment;

FIG. 19A is a schematic diagram of a cycling system for mobile device transit, according to an embodiment;

FIG. 19B is a schematic diagram of a cycling system for mobile device transit, according to an embodiment;

FIG. 19C is a schematic diagram of a cycling system for mobile device transit, according to an embodiment;

FIGS. 20A and 20B are schematic diagrams of a balloon launch system for launches to GEO, the Moon, Mars, and other destinations in the solar system and beyond, according to an embodiment;

FIGS. 21A, 21B, and 21C are schematic diagrams of systems for transmitting beams between and among airships in the airborne fleet of FIG. 9, according to an embodiment;

FIG. 22 is a schematic diagram of a system for facilitating field-riding drones and highways therefor, according to an embodiment;

FIG. 23A is a schematic diagram of a system for power transfer for charging the airborne fleet of FIG. 9, according to an embodiment;

FIG. 23B is a method for management of power transfer in a mobile grid, according to an embodiment;

FIG. 24 is a schematic diagram of a system for hybrid wireless power transmission and network management, according to an embodiment;

FIG. 25 is a schematic diagram of relay stations for dynamic transfer of power and data, according to an embodiment;

FIG. 26A is a schematic diagram illustrating wide-beam area riding highways including point-to-point power transmission, according to an embodiment;

FIG. 26B is a schematic diagram illustrating point-to-point transportation including orbit raising and descending, according to an embodiment;

FIG. 26C is a schematic diagram illustrating an MW elevator including horizontal and vertical travel, according to an embodiment;

FIG. 27 is a block diagram of a system for effecting modular swapping, according to an embodiment;

FIG. 28 is a system for in-flight charging of the airborne fleet of FIG. 9, according to an embodiment;

FIG. 29 is a hybrid system, including tethering, for power and data supply and distribution, according to an embodiment;

FIG. 30 is a hybrid network for power and data supply and distribution, according to an embodiment;

FIG. 31 is an air-water system for power and data supply and distribution, according to an embodiment; and

FIG. 32 is a system for interfacing with infrastructure of a smart city, such as the smart city devices of FIG. 1, according to an embodiment.

### DETAILED DESCRIPTION

Various apparatuses or processes may be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The present disclosure is to be understood from the perspective of utilizing a plurality of extended reality command and control stations to enable autonomous and semi-autonomous operations of mobile and fixed systems.

A ground control station (GCS) serves as a critical part of the mission of unmanned aerial vehicles (UAVs) and provides a facility for an operator to control the vehicle. Currently, research has been conducted in this area to provide portable GCSs. An enhanced portable integrated GCS system equipped with Stand-AIone Virtual Reality Head Mounted Display (ASVR-HMD) for flight test and evaluation may serve as a training tool for new pilots. Moreover, VR based flight simulators are small and more portable than a full-size cockpit mock-up simulator and are much less expensive. Accordingly, they may represent an ideal option for most operators desirous of training pilots in remote locations and performing flight operations in such remote locations.

Utilizing the same digital telemetry radio system in both real and simulated flights may advantageously provide greater consistency. The VR HMD simulators may allow pilots to accomplish a sizeable portion of real flight tests with the same data transmission techniques in a simulated environment. Accordingly, an operator may advantageously speed up the plans to use the VR headset for the real flight and provide an integrated product that aims to train pilots from flight simulation to real flights. Furthermore, the GCS equipped with VR may be provided for customers for training and operational flying purposes. Consequently, the new GCS may allow the operator to accomplish the goal of training from simulated training to actual flight with a single united system.

A Mission Control System (MCS) as herein disclosed may use an onboard camera on an aircraft. The VR HMD can be used by pilots to accomplish actual flight testing of the aircraft via real time video input enabling First-Person View (FPV) operation. A camera system captures images to integrate Computer Vision Method (CVM) algorithms. CVM allows for detecting phenomena (obstacles, objects) newly introduced into an environment and may advantageously be used to introduce a new form of autonomous operations, such as landings and obstacle avoidance. Integrating the advanced portable GCS system with the CVM algorithms may result in a lower pilot workload and may further advantageously increase situational awareness. Pilots in commercial aviation have to land aircraft manually from time to time, due to established infrastructure such as airports. CVM may allow images and markers to be tracked and commands to be associated therewith. Thus, landing (the most dangerous flight phase, in some reports accounting for more than 50% of aerial accidents) may be performed autonomously. Obstacle detection for Detect and Avoid (DAA) may be established and conditions such as bird strikes mitigated.

The proposed portable integrated GCS system may advantageously provide the benefits and efficacy of existing separate GCS and full-size cockpit mock-up simulators at a lower cost. Accordingly, instead of dealing with the physical controls, operations may be digital, with flight mechanics and dynamics of the aircraft shown on a screen using concepts of Human Machine Interfaces (HMI) through symbology design. Furthermore, VR setups are already small and portable and may accordingly be the best choice for most operational cases where customers are interested in operating in remote locations. Accordingly, a required time to train pilots may advantageously be significantly reduced compared to existing techniques and technologies, as the integrated GCS system may felicitously be used from start to finish to train the pilots for actual flight.

The present disclosure provides systems, methods, and devices for a real-time desktop flight simulator for stratospheric airship applications. The systems, methods, and devices for stratospheric airship flight simulator (SAFSim) may be used to train pilots and increase the pilots' situational awareness. The systems, methods, and devices for SAFSim may be developed using a FlightGear flight simulator. The resultant systems, methods, and devices may advantageously be scalable and low cost. In the present disclosure, the simulator architecture is described. The systems, methods, and devices for the flight simulator may allow pilots to accomplish a sizeable portion of real flight tests with the same data transmission techniques in a simulated environment. Advantageously, the flight simulator may simulate the flight environment and provide the necessary symbology and data for the pilot to better understand the stratospheric airship performance and operations at high altitudes. Advantageously, the flight simulator may be developed as modular platform to allow further development of the simulator in the context of different aircraft simulations. The real-time PC-based flight simulator may advantageously use the geometry of the airship designed for stratospheric applications along with the corresponding aerodynamics characteristics of the aircraft in the FlightGear flight simulator. Furthermore, the buyout forces, added mass, mass balance, ground reactions and propulsion contributions may advantageously be used in the flight simulator. Moreover, control surfaces that may function as a ruddervator with an X-layout and a capability to provide stability in both longitudinal and lateral-directional directions may advantageously be bound with the FrSky Taranis X9 radio transmitter. Furthermore, the present disclosure describes a heads-up display for providing aircraft performance data and environment information on a screen to increase the pilots' situational awareness. Autopilot features may be included in the flight simulator and may further include basic modes such as pitch hold and altitude hold developed with the help of PID controllers. Features and tools for data logging and real-time plotting may further be included via a “.CSV” output file working in real-time and may be connected to the real-time plotting tools.

The present disclosure provides systems, methods, and devices for an advanced virtual reality headset for stratospheric airship applications. The applications may be in satellite-denied environments. The system includes an enhanced ground/air control station equipped with an advanced virtual reality head-mounted display for long-range applications where beyond the line of sight (BLOS) operations are of interest. The advanced portable system may advantageously lower pilot workload and increase situational awareness. The enhanced ground/air control station may advantageously provide robust BLOS flight operations in satellite-denied environments at stratospheric altitudes. The virtual reality head-mounted display may enable a pilot to accomplish a sizeable portion of real flight tests with the same data transmission techniques in a simulated environment. As a result, the new GACS may enable the operator to move from simulated training to actual flight with a single united system. In order to implement the systems, methods, and devices as described in the present disclosure, a commercial-off-the-shelf virtual reality headset may be connected to the stratospheric airship simulation tool. The virtual reality head-mounted display may visualize basic flight simulation and enhance the design procedure of the stratospheric airship via simulation tool. Furthermore, an onboard camera may be integrated into the stratospheric airship to provide real-time flight capability. The virtual reality head-mounted display may be used by pilots to accomplish actual flight testing via real-time video input enabling first-person view operation. The view from actual flight test to simulated flight test may advantageously be combined by providing the necessary symbology and data for the pilot to better understand the airship performance and operations in satellite-denied environments. Finally, the development of a fleet management system may be tested to provide simulated vs. real flight test data for all aircraft.

The present disclosure provides systems, methods, and devices for high-altitude platforms with long endurance (e.g. over multiple months) an operational altitude up to 65,000 feet or greater, and that may provide multiple payloads across multiple missions. The high-altitude platforms (HAP) may have a beyond loss of sight (HAP-BLOS) communication system, an active three-dimensional phased array antenna, a virtual reality command and control station, an energy generation system, and a ground control station. The HAP may be further equipped for fleet operation through the presence of an enhanced hot air balloon and/or airship balloon architecture. The HAP may be equipped for autonomous flight missions. The HAP may provide for human control of aerial vehicles.

An RC controller may bind with a simulation model. A commercial-off-the-shelf stand-alone virtual reality headset may be connected to the aircraft simulation tool and bound to the RC controller. A flight simulation stream may be presented in the VR headset using a virtual desktop app, Sidequest, and Wi-Fi. FRSky RC controller modelling may be performed in Solidworks. Functions definition of the FRSky RC controller may be performed using Unity. A heads-up display may be used to provide essential flight information to the pilot.

The RC controller tracker may be modelled and 3D-printed. There may be provided an Insta 360 Camera stream on a computer. The camera may be bound with the VR headset. There may further be integration of the 360 Camera with a drone and the VR headset.

A Mission Control System (MCS) using an onboard camera on the aircraft may be implemented to provide realtime flight visualization. Position and orientation data of the onboard camera and flight may be sent to ground control station (GCS) software in the VR headset. Commanding the inputs may be performed using the same radio transmitter used for the VR-HMD platform (e.g., FRSky Taranis X9D) based on an embedded code compatible with GCS software (e.g., via VAPS XT). A design of the flight deck may be implemented. The designed flight deck for the VR-HMD may be adapted with the GCS software in the headset.

Autonomous operation may be performed using computer vision algorithms. Obstacle and object detection may be performed using computer vision, allowing tracking of obstacles and objects in a flight path to Detect and Avoid (DAA) and recognize size, orientation, and motion.

Fleet tracking architecture and swarm flight formation may further enhance an overall situational awareness of an operator. This can be understood as an arrangement of each airship in relation to another airship in swarming, maintaining a parent-child concept.

Complete asset tracking and command and control capabilities may be integrated to support operations of the entire fleet. This may advantageously provide advanced situational awareness, minimize accidents, and enhance traffic and operational capabilities. Systems, methods, and devices for implementing this functionality may accordingly act as autonomous virtual air traffic control/management (AV-ATC/M) systems, methods, and devices, respectively.

The vehicles associated with the high altitude platforms in the systems, methods, and devices as described in the pleasant disclosure may be unmanned airships. The unmanned airships may belong to unmanned aircraft systems. The unmanned airships may be capable of undertaking ultralong flights of up to four months or longer. The unmanned airships may be capable of transporting a payload of up to 50 kg. The unmanned airships may be capable of operating at altitudes of between 3 and 22 km. The unmanned airships may be powered through any one or more of solar, directed power, and thermal systems.

AIthough the term ground control station (GCS) may imply a location on the ground or on the surface of the Earth, the control station as described and as claimed herein need not be located on the ground. AIl references to the ground control station or GCS herein are understood to include control stations not located on the ground.

Similarly, although the control station may be described as separate from any system, subsystem, or component thereof that provides sensor input, the control station functionality or at least a part thereof may be a part of another system, subsystem, or component herein and may not be separate therefrom. Accordingly, all references to the control station are understood to include references to another system, subsystem, or component of the system into which the control station or some or all of the functionality thereof may be integrated.

Firstly, a Commercial-off-the-shelf (COTS) stand-alone Virtual Reality (VR) headset may be connected to an aircraft simulation tool. The VR HMD may be used to visualize basic flight simulation via a simulation tool for different air and space vehicles.

Secondly, an onboard camera may be integrated into the proposed aircraft. The VR HMD referenced hereinabove may be used by a pilot to accomplish actual flight testing via real time video input enabling First-Person View (FPV) operation.

A main focus of the present disclosure is combining the view from actual flight test to simulated flight test, i.e., combining data from a test vehicle and simulated results and visualizing same in extended reality, by providing the necessary symbology and data for the pilot to better understand the aircraft performance and operations for validation.

Provided herein are systems and methods for an extended reality ground control station, systems and methods for 3D input devices, to control 3D environment, systems and methods for intuitive haptic control, feedback, and interactions, systems and methods for high fidelity, a single united system for operations, training, and evaluation, systems and control of a deployable mobile network, systems and methods of in-situ monitoring, relay communication services, and emergency response, systems and methods of fleet management for sustaining continuous operations for ultralong flight, including in situ monitoring, systems and methods for take-off and landing for mobile systems, systems and methods for autonomous and semi-autonomous operations, including take off and landing, systems and methods of operating at multiple altitudes and orbits, systems and methods for real-time operating of multi-domain applications (land, air, water, and space) to interface with devices on the ground and in the air and in space, and systems and methods for data management for a mobile network, including any of downlink, uplink, and cloud-based storage.

The extended reality disclosed herein may include augmented reality for providing realistic, meaningful, and engaging augmented experiences; virtual reality for conceptualization, design, development, and fully equipped tests according to client needs, and mixed reality for providing customized augmented reality/virtual reality and 360-degree solutions development for a wide range of applications. Associated services are of an end-to-end nature.

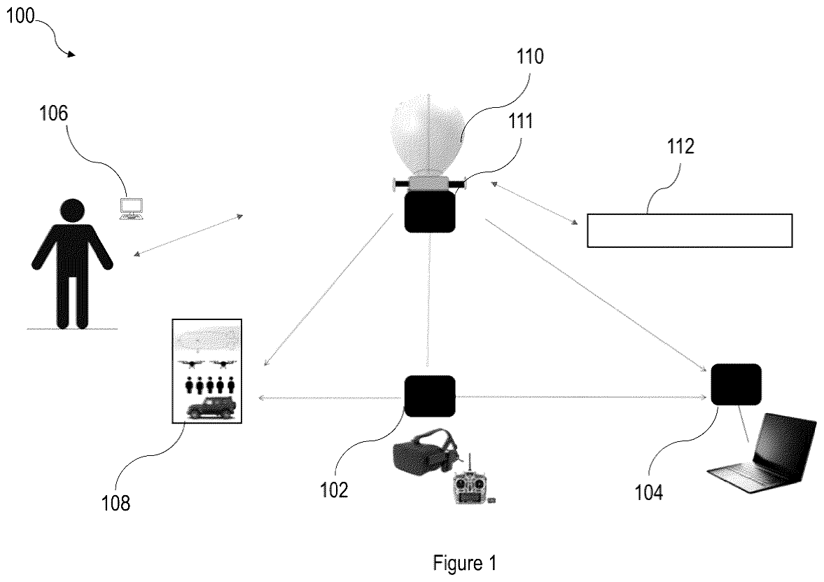

Referring now to FIG. 1, shown therein is a schematic diagram of a system 100 for a remote control station, according to an embodiment.

The system 100 includes primary receivers 102 and 104 for providing primary command and control of mobile devices 108, a secondary receiver 106 for providing secondary command and control of the mobile devices 108, the mobile devices 108, a relay platform 110 for relaying command and control signals and other information, and smart city devices 112.

The smart city devices 112 may include devices for gas and water leak detection, public safety, Internet of Things, traffic management, smart health, intelligent shopping, education, smart environment, air pollution, smart buildings, open data, electromagnetic emissions, smart home, and/or smart street lights, etc.

The primary receivers 102 and 104 provide primary command and control with respect to the system 100 to a user. In an embodiment, the primary receiver 102 includes remote controls (e.g. featuring a joystick configuration) suitable for providing command and control to the user over the mobile devices 108. The primary receiver 102 further includes a vision component, such as wearable goggles, to provide enhanced reality functionality to the user. Enhanced reality may include ordinary reality, virtual reality, augmented reality, or similar applications.

In an embodiment, the primary receiver 104 includes ordinary commercial electronic devices. In an embodiment, the primary receiver 104 is a laptop.

The secondary receiver 106 may be a device associated with an individual user. In an embodiment, the secondary receiver 106 may be an object worn about the person of the user, such as a glove. The secondary receiver 106 may provide haptic feedback to the user with respect to the operations and/or movement of the mobile devices 108. The user may use the secondary receiver 106 to gain secondary command and control over the mobile devices 108. The user may effect secondary command and control through gestures, voice commands, or otherwise.

The primary receivers 102, 104 may provide primary haptic control. The secondary receiver 108 may provide secondary haptic control.

The mobile devices 108 are controlled by the primary receivers 102, 104 and by the secondary receiver 106. In an embodiment, the mobile devices 108 include any of cars, trucks, or other commercial vehicles; drones, airships, or other personal aircraft; ships, boats, and other watercraft; rockets, satellites, and other spacecraft; and any other vehicles or mobile devices configured to be or capable of being remotely controlled, piloted, and/or operated. The mobile device 108 may be a flight-enabled vehicle including computing and communication equipment necessary for performing the functions of the mobile device 108 in the system 100, such as data processing and communication with other components of system 100.

The mobile device 108 may include a computer-readable storage medium storing and processing computer vision method algorithms for detecting obstacles and objects.

The mobile device may be configured to provide data, both raw and processed, and camera feed to the secondary receiver 106. In such a configuration, the secondary receiver 106 may include an extended reality headset.

The mobile device may comprise a robotic arm suitable for grasping, manipulating, and moving objects or the like.

The relay platform 110 includes a camera 111 for photographing, recording, and transmitting visual information (e.g. image data) of interest throughout the system 100 and to any components thereof in particular.

The relay platform 110 receives, transmits, and retransmits command and control signals and other information throughout the system 100. In an embodiment, the relay platform 110 may be a high-altitude relay platform. The high-altitude relay platform is positioned at a significant height above the Earth. Such a location may advantageously facilitate communication and/or efficacy of the camera 111.

The smart city devices 112 are in communication with the relay platform 110. The smart city devices 112 may include Internet of Things (“IoT”) devices running or communicating with IoT applications. The smart city devices 112 may include, for example, smart street lights, public safety devices, and smart buildings.

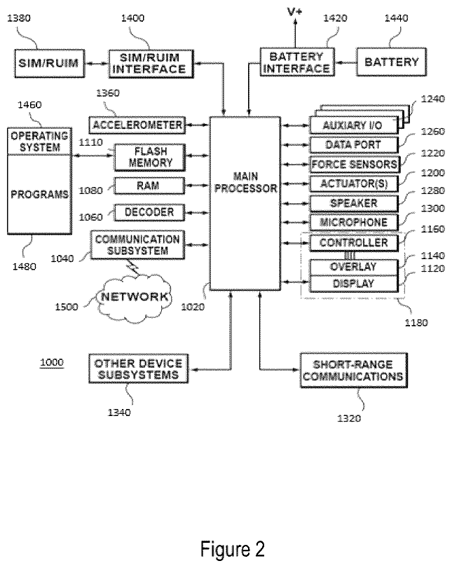

Referring now to FIG. 2, shown therein is a simplified block diagram of components of a computing device 1000 of the system 100, according to an embodiment. The computing device 1000 may be a mobile device or portable electronic device. The computing device 1000 includes multiple components such as a processor 1020 that controls the operations of the computing device 1000. Communication functions, including data communications, voice communications, or both may be performed through a communication subsystem 1040. Data received by the computing device 1000 may be decompressed and decrypted by a decoder 1060. The communication subsystem 1040 may receive messages from and send messages to a wireless network 1500.

The wireless network 1500 may be any type of wireless network, including, but not limited to, data-centric wireless networks, voice-centric wireless networks, and dual-mode networks that support both voice and data communications.

The computing device 1000 may be a battery-powered device and as shown includes a battery interface 1420 for receiving one or more rechargeable batteries 1440.

The processor 1020 also interacts with additional subsystems such as a Random Access Memory (RAM) 1080, a flash memory 1110, a display 1120 (e.g., with a touch-sensitive overlay 1140 connected to an electronic controller 1160 that together comprise a touch-sensitive display 1180), an actuator assembly 1200, one or more optional force sensors 1220, an auxiliary input/output (I/O) subsystem 1240, a data port 1260, a speaker 1280, a microphone 1300, short-range communications systems 1320 and other device subsystems 1340.

In some embodiments, user-interaction with the graphical user interface may be performed through the touch-sensitive overlay 1140. The processor 1020 may interact with the touch-sensitive overlay 1140 via the electronic controller 1160. Information, such as text, characters, symbols, images, icons, and other items that may be displayed or rendered on a computing device generated by the processor 1020 may be displayed on the touch-sensitive display 1180.

The processor 1020 may also interact with an accelerometer 1360. The accelerometer 1360 may be utilized for detecting direction of gravitational forces or gravity-induced reaction forces.

To identify a subscriber for network access according to the present embodiment, the computing device 1000 may use a Subscriber Identity Module or a Removable User Identity Module (SIM/RUIM) card 1380 inserted into a SIM/RUIM interface 1400 for communication with a network (such as the wireless network 1500). AIternatively, user identification information may be programmed into the flash memory 1110 or performed using other techniques.

The computing device 1000 also includes an operating system 1460 and software components 1480 that are executed by the processor 1020 and which may be stored in a persistent data storage device such as the flash memory 1110. Additional applications may be loaded onto the computing device 1000 through the wireless network 1500, the auxiliary I/O subsystem 1240, the data port 1260, the short-range communications subsystem 1320, or any other suitable device subsystem 1340.

In use, a received signal such as a text message, an e-mail message, web page download, or other data may be processed by the communication subsystem 1040 and input to the processor 1020. The processor 1020 then processes the received signal for output to the display 1120 or alternatively to the auxiliary I/O subsystem 1240. A subscriber may also compose data items, such as e-mail messages, for example, which may be transmitted over the wireless network 1500 through the communication subsystem 1040.

For voice communications, the overall operation of the computing device 1000 may be similar. The speaker 1280 may output audible information converted from electrical signals, and the microphone 1300 may convert audible information into electrical signals for processing.

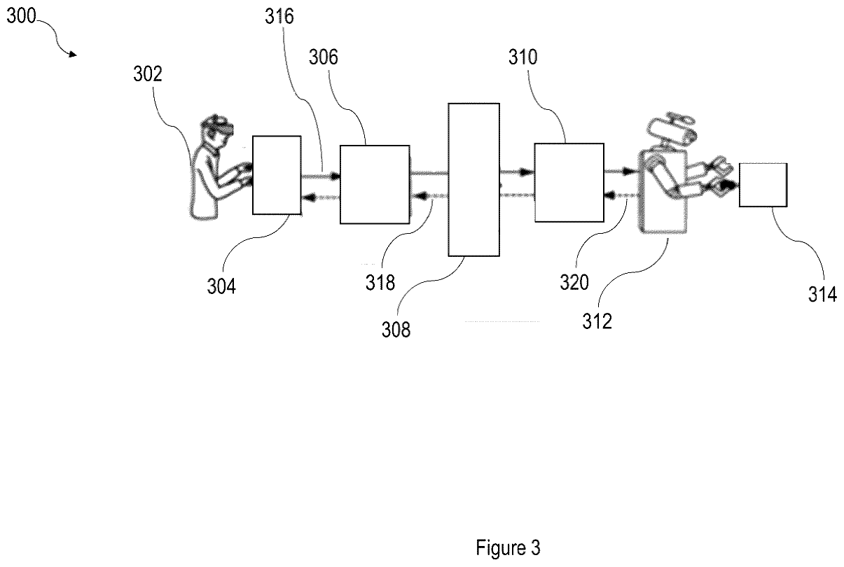

Referring now to FIG. 3, shown therein is a generalized system 300 for remote operation through transmission and reception of command and control signals and operator/machine feedback information and sensor information, according to an embodiment.

In an embodiment, the system 300 of FIG. 3 may be the system 100 of FIG. 1 or implemented as a component thereof.

The system 300 includes a user 302 for operating the system 300 so as to generate command and control signals 316. In an embodiment, the user is a human operator. The user 302 may also be remotely controlled by a different user. In an embodiment, the user generates command and control signals through physical manipulation of a master/haptic interface 304.

The system 300 further includes the master/haptic interface 304 for receiving user manipulation and generate command and control signals 316 for transmission downstream. In an embodiment, the master/haptic interface 304 includes a lever, buttons, or other physical devices or components susceptible to physical manipulation by the user 302.

The system 300 further includes a master control device 306 for receiving the command and control signals 316 for instructing a slave/teleoperator 312 on interaction in a remote environment 314. The master control device 306 propagates the command and control signals 316 downstream of the system 300.

The system 300 further includes a communication channel 308 for further transmission of the command and control signals 316 downstream of the system 300 to a slave control device 310.

The system 300 further includes the slave control device 310 for receiving the command and control signals 316 from the master control device 306 through the communication channel 308. According to the command and control signals 316, the slave control device 310 controls the behaviour of a slave/teleoperator device 312 for carrying out the command and control signals 316. In an embodiment, the slave/teleoperator device 312 may be a robot, including a robotic arm. The robotic arm may be capable of moving an object.

According to the command and control signals 316, the slave/teleoperator device 312 interacts with a remote environment 314. The remote environment 314 is remote to the user 302. Accordingly, the user 302 may not be able to interact with the remote environment 314 directly.

Interaction between the slave/teleoperator device 312 and the remote environment 314 produces sensor information 318. The sensor information may be, for example, an image of the remote environment 314. Such interaction may further produce feedback information 320, for example, confirmation that a task is completed by the slave/teleoperator device 312.

The sensor information 318 and feedback information 320 are transmitted upstream through the slave/teleoperator 312, the slave control device 310, the communication channel 308, the master control device 306, the master/haptic interface 304, and to the user 302.

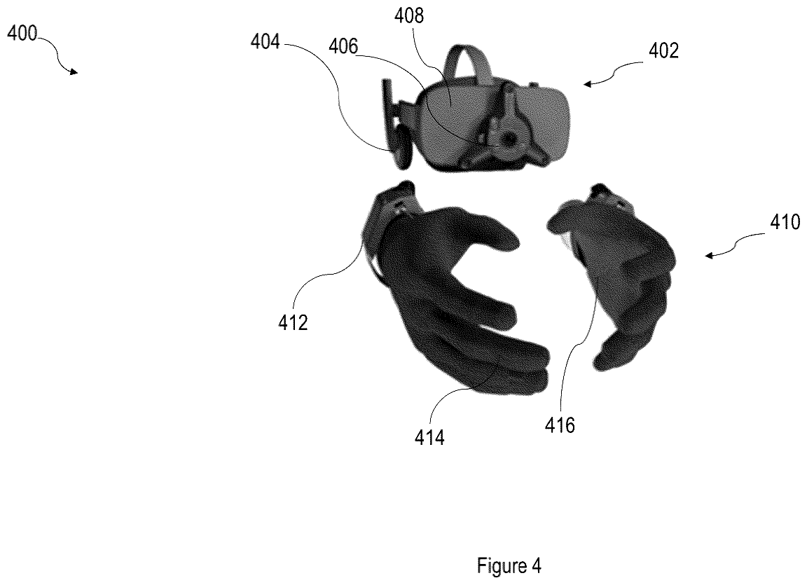

Referring now to FIG. 4, shown therein is a user device 400, according to an embodiment. The user device 400 may be the secondary receiver 106 of FIG. 1. The user device 400 may worn by the user 302 of FIG. 3.

The device 400 includes a sensory component 402 for providing feedback information and sensor information to a user (not shown) and a haptic component 410 for the user to provide command and control instructions.

The sensory component 402 includes an auditory interface 404 for providing auditory information to the user, an extended reality interface 406 for providing extended reality visual information to the user, and a blinder 408 for blocking out the user's ordinary line of sight when interfacing with the extended reality interface 406.

The haptic component 410 includes wrist sensors 412 for sensing motion, orientation, or gesticulation by the user, finger sensors 414 for sensing tapping or other finger motions made by the user, and palm sensors 416 for sensing pressure applied against a user's palm, for example due to closing a hand, clapping hands together, or pressing the user's palm against a surface or object.

The sensory component 402 may further be configured for virtual reality/augmented reality and control and feedback. The sensory component 402 may further be configured for object recognition.

The device 400 may further be configured for advanced robotic arm control. The device 400 may further be configured for rehabilitation.

The haptic component 410 may further be configured for any of bending, sliding, haptic stimulation, and/or other three dimensional inputs.

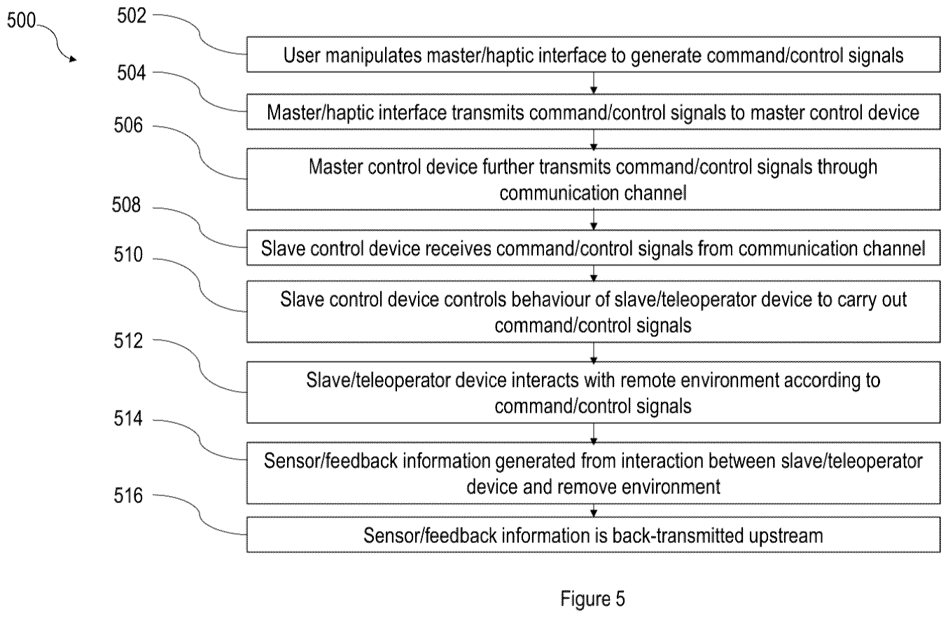

Referring now to FIG. 5, shown therein is a flow diagram of a method 500 for using a remote control station to interact with a remote environment, according to an embodiment. The method 500 may be implemented, for example, by the system 300 of FIG. 3.

At 502, a user manipulates a master/haptic interface to generate command and control signals.

At 504, the master/haptic interface transmits the command and control signals to a master control device.

At 506, the master control device further transmits the command and control signals through a communication channel.

At 508, a slave control device receives the command and control signals from the communication channel.

At 510, the slave control device controls behaviour of a slave/teleoperator device in order to carry out the command and control signals.

At 512, the slave/teleoperator device interacts with a remote environment according to the command and control signals.

At 514, sensor information and feedback information are generated from interaction between the slave/teleoperator device and the remote environment.

At 516, the sensor information and the feedback information are back-transmitted to the slave control device, the communication channel, the master control device, the master/haptic interface, and the user.

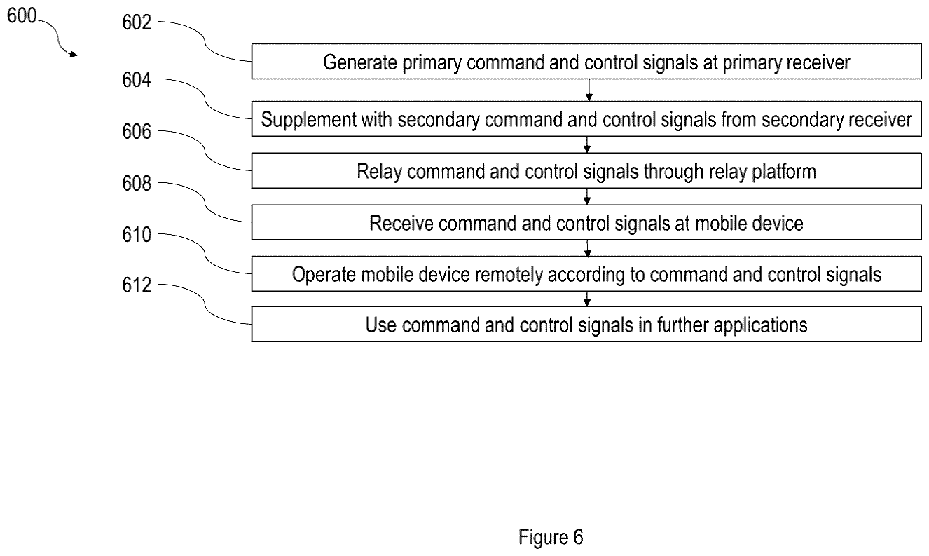

Referring now to FIG. 6, shown therein is a flow diagram of a method 600 for using a remote control station to operate a mobile device remotely, according to an embodiment. The method 600 may be implemented, for example, by the system 100 of FIG. 1.

At 602, primary command and control signals are generated at a primary receiver.

At 604, the primary command and control signals are supplemented with secondary command and control signals from a secondary receiver.

At 606, the primary and secondary command and control signals are relayed through a relay platform.

At 608, the primary and secondary command and control signals are received at a mobile device.

At 610, the mobile device is operated remotely according to the primary and secondary command and control signals.

At 612, the primary and secondary command and control signals are used in further applications. For example, the primary and secondary command and control signals may be communicated to one or more smart city devices (e.g. smart city devices 112 of FIG. 1).

In either of method 500 or 600, there may be a further step of providing data, both raw and processed, and camera feed from the mobile device to an extended reality headset.

The mobile device may include a computer-readable storage medium storing and processing computer vision method algorithms for detecting obstacles and objects.

The mobile device may comprise a robotic arm suitable for grasping, manipulating, and moving objects and the like.

Either of method 500 or 600 may further comprise performing the relaying, receiving, and/or operating steps for at least one additional mobile device.

Either of method 500 or 600 may further comprise collecting data via a data collection subsystem, analyzing the data via a distributed data processing pipeline, and providing data management and pilot training through a visualization subsystem.

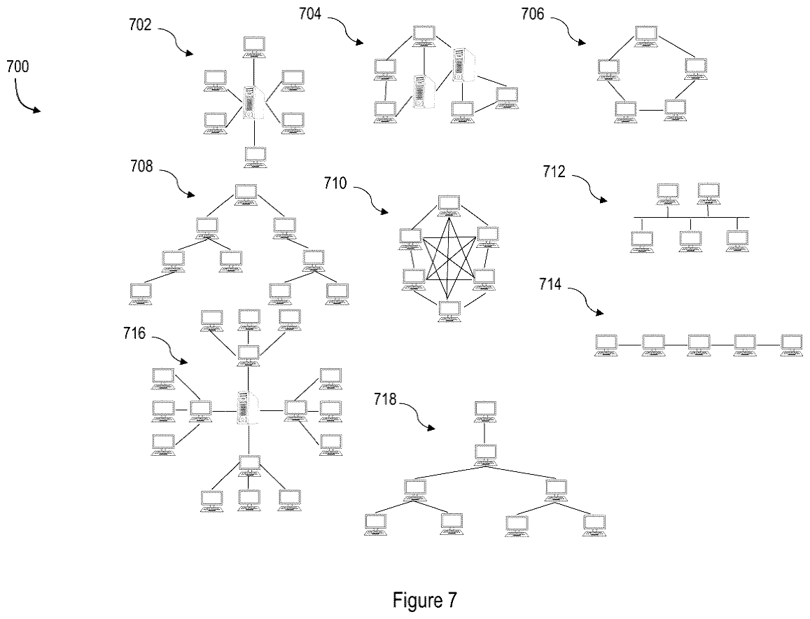

Referring now to FIG. 7, shown therein is an overview of different possible network node configurations 700, according to embodiments.

Configuration 702 represents a star configuration wherein each node is connected to a central source.

Configuration 704 represents a mesh configuration wherein each node may be connected to the source and/or to one or more other nodes.

Configuration 706 represents a ring configuration wherein each node is connected to exactly two other nodes, forming a complete circle.

Configuration 708 represents a tree configuration, wherein each node except one is connected to a parent node and to between zero and two children nodes.

Configuration 710 represents a fully connected configuration, wherein each node is connected to each other node.

Configuration 712 represents a bus configuration, wherein each node is connected only to a central bus and the central bus is connected to each node.

Configuration 714 represents a line configuration wherein each node is connected to between 1 and 2 other nodes, forming a single line.

Configuration 716 represents an extended star configuration, wherein each node of the star configuration 702 is connected to three further nodes.

Configuration 718 represents a hierarchical configuration, wherein each node except one is connected to a parent node and to between zero and two children nodes.

Network nodes may be arranged as fixed, mobile, and hybrid systems as shown therein. The network nodes may facilitate a method for connecting to a three-dimensional configurations of satellites or other space systems, drones, airships, cars, trucks, boats, self-sustaining fixed units, vehicles, or spacecraft or the like that may be continuous as in a crystalline structure or random as in a flock of birds. Both 2D and 3D configurations thereof are possible. Nodes may transmit, receive and store, power and/or data. An associated system may dynamically manage power systems to optimize stored data amongst nodes. Such a distributed system may charge using different topologies: transfer power from source to the node; and then node to node (power relay system).

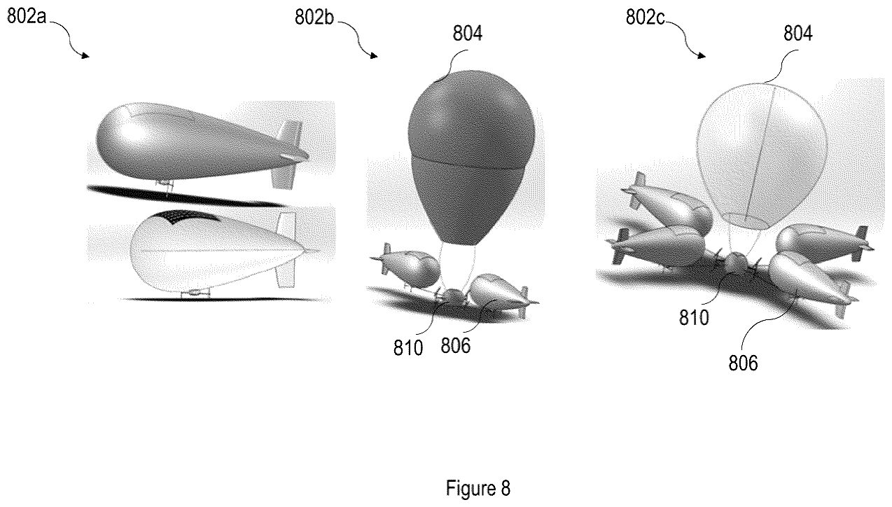

Referring now to FIG. 8, shown therein are airship configurations 802a, 802b, and 802c suitable for use as mobile device 108 of the system 100 for a remote control station of FIG. 1, according to embodiments.

Referring to airship configurations 802b and 802c in particular, the airship configurations 802b, 802c include a hot air balloon 804 for providing buoyance to the airship configurations.

The airship configurations 802b and 802c further include airships 806 for performing the functions of a mobile device 108 in the system 100.

The airship configurations 802b and 802c further include anchoring platforms 810 for connecting the balloon 804 to the airships 806.

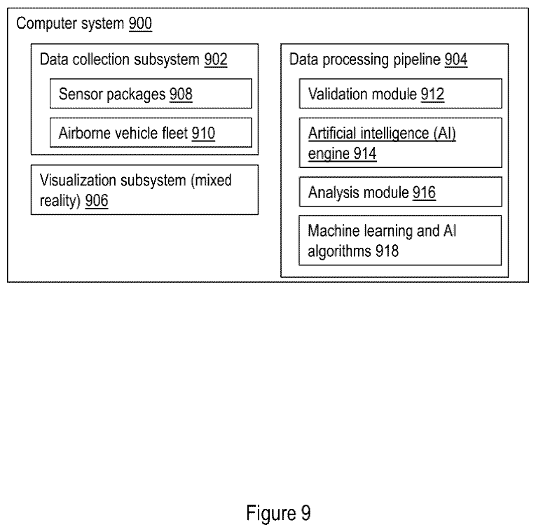

Referring now to FIG. 9, shown therein is a computer system 900 for supporting real-time operations of the systems, methods, and devices of the present disclosure, according to an embodiment.

The computer system 900 includes a data collection subsystem 902 for data collection. The data collection subsystem 902 includes sensor packages 908 for obtaining data observed by an airborne vehicle fleet 910 associated with the data collection subsystem 902. The airborne vehicle fleet 910 may include the mobile devices 108 of FIG. 1.

The computer system 900 further includes a distributed data processing pipeline 904 for processing the data collected by the data collection subsystem 902. The data processing pipeline 904 further includes a validation module 912 for validating the data, an artificial intelligence (AI) engine 914 for applying artificial intelligence techniques to the data, an analysis module 916 for analyzing the data, and machine learning and AI algorithms 918 for drawing conclusions from the data.

The computer system 900 further includes a visualization subsystem (mixed reality) for presenting augmented and/or virtual reality to a user of the computer system 900. For example, the computer system 900 through the visualization subsystem (mixed reality) 906 may present data collected by the data collection subsystem 902 from the airborne vehicle fleet 910, the results of analysis by analysis module 916 and conclusions drawn from machine learning and AI algorithms 918, or both.

The subsystems of the computer system 900 may be integrated into a node and serve as a data processing node. In a distributed system, raw and processed data can be moved from node to node for processing and downlink.

The validation module 912 may have machine learning and/or artificial intelligence components to process data. Data may be compared to AI models (not shown) for analysis.

Data may be collected using a vehicle (not shown). Data may be processed onboard the vehicle or sent to another vehicle for processing. For example, a daughter drone may collect data and send the data to a parent drone for processing.

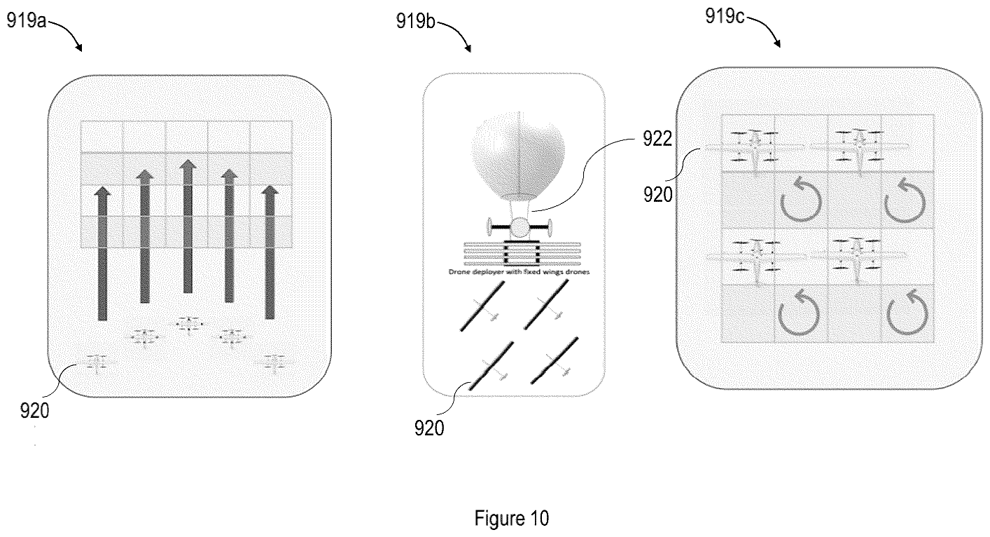

Referring now to FIG. 10, shown therein representations of deployments 919a, 919b, 919c of the airborne vehicle fleet 910, according to embodiments.

The airborne vehicle fleet 910 includes drones 920 for rapid monitoring of large areas of interest. The airborne vehicle fleet 910 may form through pre-determined routes of the drones 920. The drones 920 may include hovering capabilities. The entire airborne vehicle fleet 910 may demonstrate system scalability so as to be easily deployable.

The airborne vehicle fleet 910 further includes airships 922 for deploying drones.

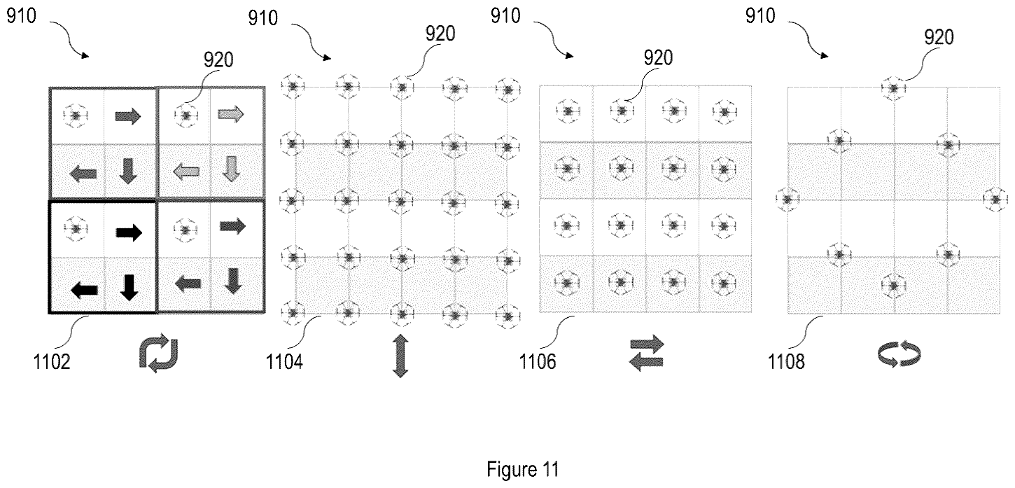

Referring now to FIG. 11, shown therein are representations of different flight patterns 1102, 1104, 1106, 1108 of the airborne vehicle fleet 910 in collecting data, according to embodiments.

Flight pattern 1102 shows each drone 920 travelling independently throughout a subsection of a range. For example, in view 1102, each drone 920 travels in a clockwise fashion throughout its subsection.

Flight pattern 1104 shows each drone 920 travelling along a vertical column within the range. For example, in view 1104, each drone 920 proceeds along the vertices of squares drawn over the range.

Flight pattern 1106 shows each drone 920 travelling along a horizontal row within the range. For example, in view 1106, each drone 920 proceeds along the faces of squares drawn over the range.

Flight pattern 1108 shows the airborne fleet 910 travelling together in a circular pattern within the range.

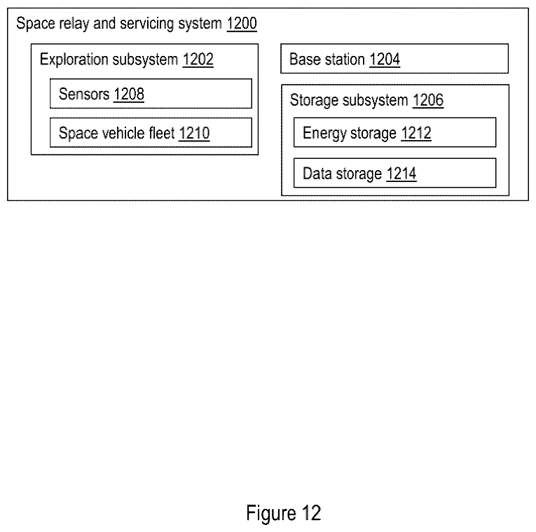

Referring now to FIG. 12, shown therein is a block diagram of a space relay and servicing system 1200 for facilitating data collection and mobile fleet use in outer space, according to an embodiment.

Advantageously, in an embodiment, the same system as previously described in the present disclosure may operate in space using similar if not identical methodology. Advantageously, the same systems may operate on land, air, water, and space using the same technology but with different implementations in accordance with the domain, i.e., a fleet of systems operating in a specific domain.

The system 1200 may facilitate communication with components or devices on a celestial body (celestial body-based), in free space (free space-based), or both.

The space relay and servicing system 1200 includes an exploration subsystem 1202 for exploring. Exploration may occur upon or about a celestial body or within outer space independent of any structure, object, or body, whether natural or man-made (e.g. a free space structure).

The exploration subsystem 1202 includes sensors 1208 for receiving information about the space vehicle fleet 1210. In an embodiment, the sensors 1208 may be mounted on vehicles belonging to the space vehicle fleet 1210. In an embodiment, the sensors may be mounted upon a celestial structure, object, or body. In an embodiment, the space vehicle fleet 1210 may include drones 920 and airships 922 as described in the computer system 900. Such drones 920 and airships 922 may be adapted for use in outer space. In an embodiment, the space vehicle fleet 1210 may include vehicles not present in the airborne fleet 910.

The space relay and servicing system 1200 further includes a base station 1204 for communication with the rest of the system 1200. Human operators may be located inside this node of the system 1200.

The space relay and servicing system 1200 further includes a storage subsystem 1206. The storage subsystem 1206 includes energy storage 1212 for storing energy for vehicles of the space vehicle fleet 1210. In an embodiment, the energy storage 1212 may be a battery.

The storage subsystem 1206 further includes data storage 1214 for storing data collected by the sensors 1208 and/or the space vehicle fleet 1210. In an embodiment, the data storage 1214 may be a computer, a computer memory, or other commercially available data storage means.

Outer space is another domain in which an extended reality control station as described in the present disclosure can operate. The system may connect all domains for command and control operations.

Different challenges may be present in the space domain with unique environments that the system may cater to.

To reduce lag time and optimize network communication, data may be processed in orbit and key insights may be transmitted through the system 1200 to a desired node and/or downlinking purposes.

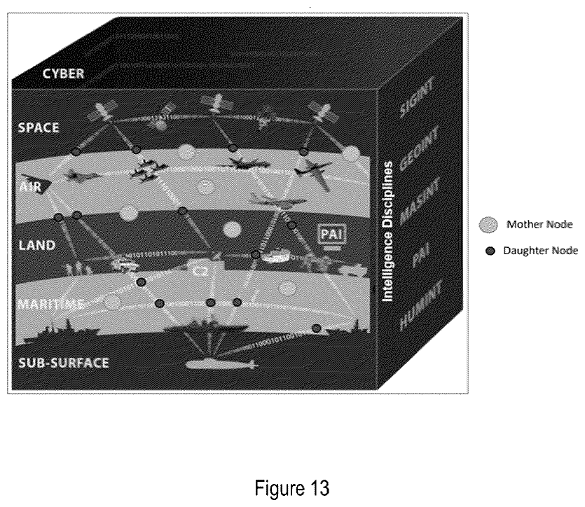

Referring now to FIG. 13, shown therein is a view of a system for remote control of mobile devices in operation.

In the system, 3D input devices to control a 3D multi-orbit and multi-domain environment for real-time, autonomous and semi-autonomous operations are provided. The system may advantageously increase situational awareness and facilitate command and control of realtime operations across multiple domains in respect of multiple vehicles. The vehicles may form an array of multi-domain capabilities. The system may further include a data network, platforms, sensors, and operators.

A wide variety of platforms (satellites, aircraft, ships, humans, etc.) and sensors (imagery, communications, acoustics, etc.) collect, analyze, and share data, information, and intelligence across multiple warfighting domains. The focus of ISR is on answering a commander's information needs, such as identifying and locating adversary activity and intentions within a given battlespace. Specific intelligence disciplines include but are not limited to Signals Intelligence, Geospatial Intelligence, Measurement and Signatures Intelligence, Publicly Available Information, and Human Intelligence.

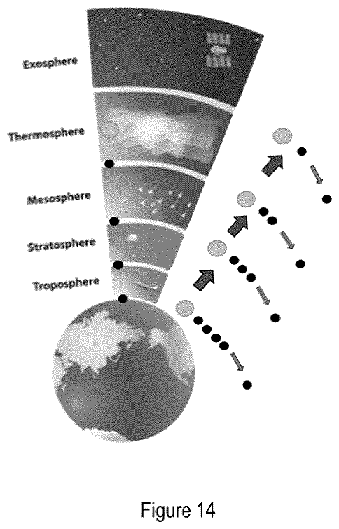

Referring now to FIG. 14, shown therein is a view of a hybrid deployment system and method for a control station.

The method may include inflating and deploying one or more systems as a balloon goes higher into each sphere of operation. The method may further include deploying an independent system to create a network, from an airplane, by ship, car, train, drones, and/or other airships or the like, etc.

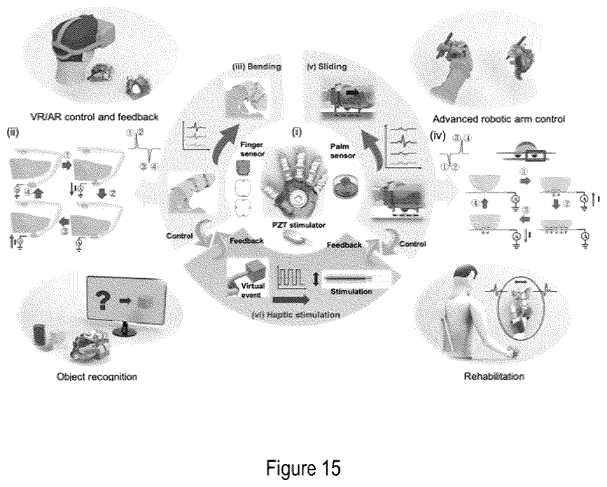

Referring now to FIG. 15, shown therein is a conceptual view of different 3D input device applications of the haptic control of the secondary receiver 106 of FIG. 1.

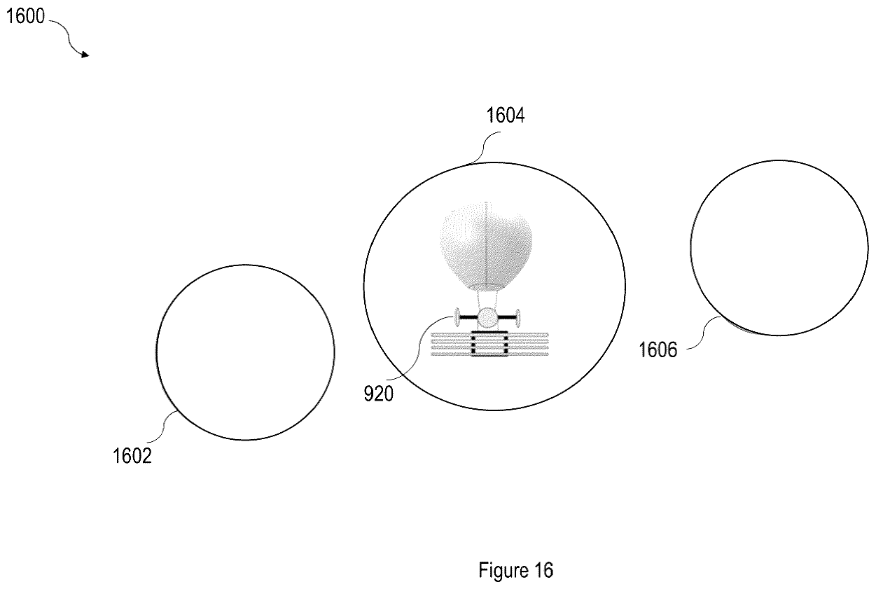

Referring now to FIG. 16, shown therein is a view of spheres of operation 1600 of the drones 920 of FIG. 10.

The spheres of operation 1600 provide autonomous control according to pre-programmed primary and secondary control by 3D space. The spheres of operation 1600 include designated servicing and maintenance zones and waiting zones for safe operations.

The spheres of operation 1600 include a yellow zone where there occurs a hand-off from an operator of a green zone 1606 to autonomous control of a red zone 1604.

The spheres of operation 1600 further include the red zone 1604 where only autonomous control of the drones 920 is permitted.

The spheres of operation 1600 further include a green zone where control is handed back to another operator.

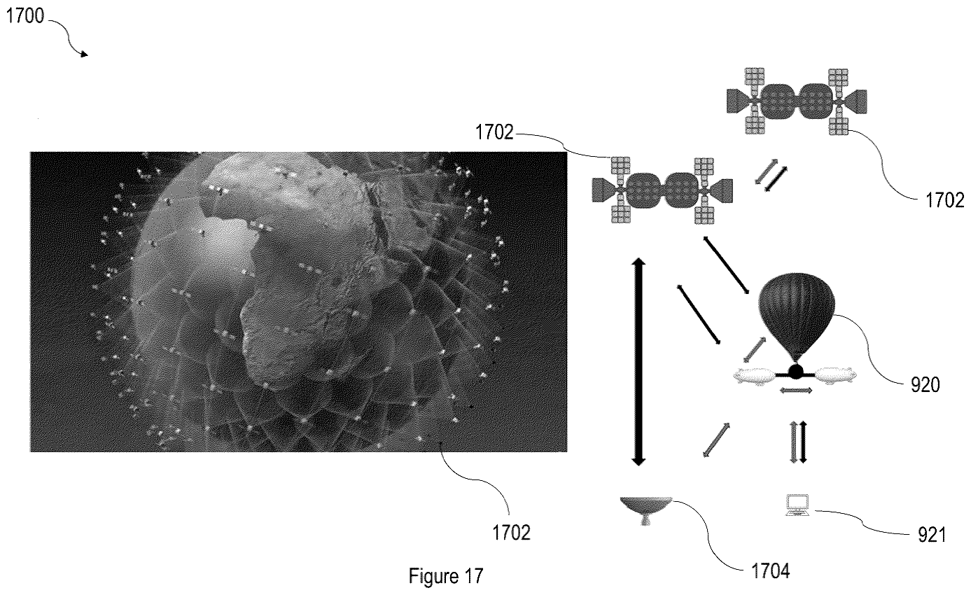

Referring now to FIG. 17, shown therein is a schematic view of a multi-domain command and control system 1700 for fleets of mobile and fixed nodes, such as drones 920, to perform autonomous and/or semi-autonomous operations.

The system may include other fixed/mobile nodes, such as other drones 921.

The system 1700 may be capable of asset tracking, monitoring, and management.

The system 1700 includes satellites 1702 that act as fleets of mobile and/or fixed nodes.

The system 1700 further includes communications equipment 1704 for transmitting signals to and receiving signals from the satellites 1702 and/or the drones 920.

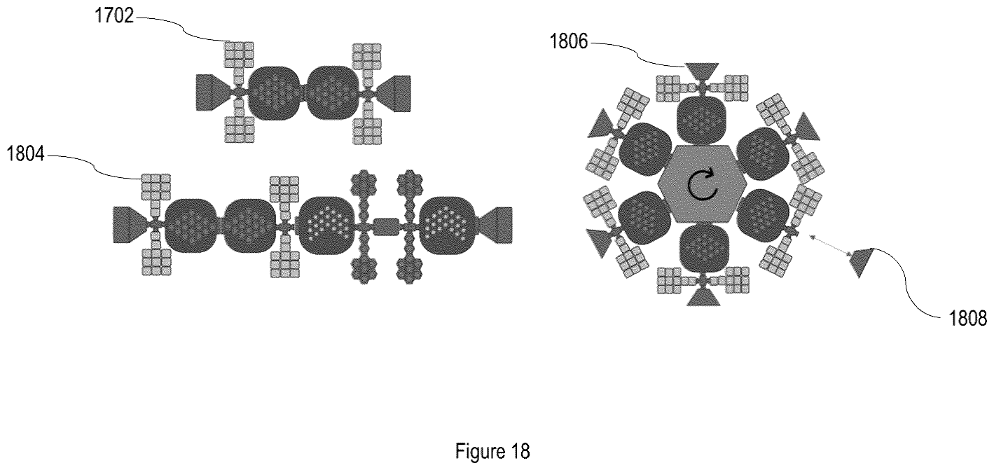

Referring now to FIG. 18, shown therein is a system for in-orbit assembly of mobile devices, such as the mobile devices 108 of FIG. 1.

Modular systems may be assembled in orbit to create larger systems in space. For example, a satellite 1702 may be combined with other components and/or systems in order to create satellite systems 1804, 1806.

The satellite system 1806 is further depicted mid-assembly, with a satellite component 1808 being added thereto.

Spin-stabilized, robotic arms may support rendezvous operations of space systems.

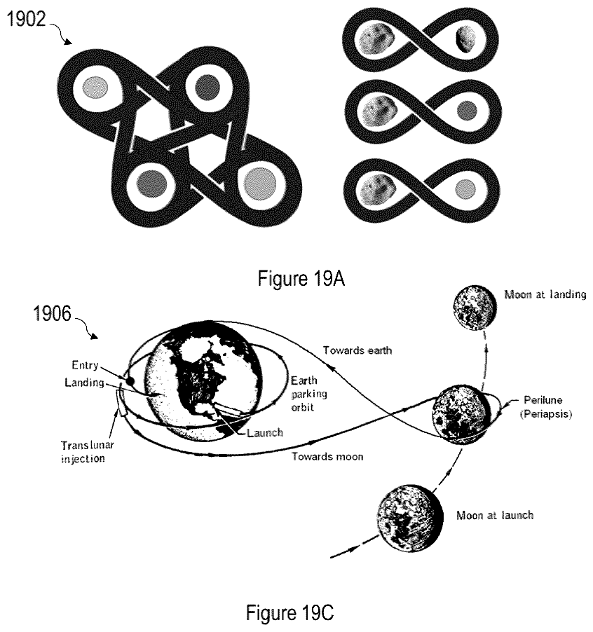

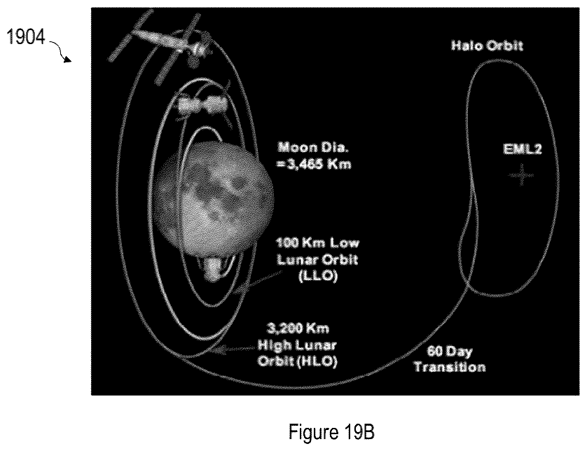

Referring now to FIGS. 19A, 19B, and 19C, shown therein are cycling systems 1902, 1904, and 1906, respectively for mobile device transit.

The cycling systems may operate between 2 points in space such as planets, moons, planetoids, asteroids, and other celestial bodies, and/or the like

Referring in particular to FIG. 19B, shown therein are examples of low lunar orbit (at 100 km), high lunar orbit (at 3,200 km), and halo orbit (about EML2 with a 60-day transition) about the moon at diameter 3,465 km.

Referring in particular to FIG. 19C, shown therein is a flight path about the Earth and towards and about the moon.

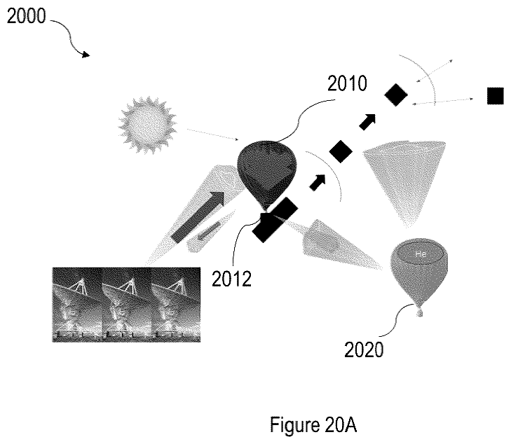

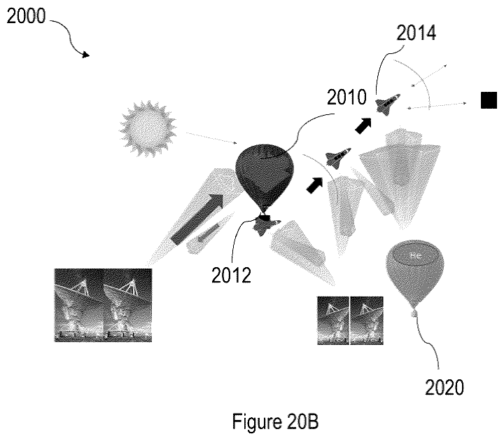

Referring now to FIGS. 20A and 20B, shown therein is a balloon launch system for launches to GEO, the Moon, Mars, and other destinations in the solar system and beyond.

In the system 2000, payloads go to LEO, MEO, HEO, Sun-synchronous orbits, etc.

The system 2000 includes a primary airship 2010 for carrying a payload 2012.

A secondary airship 2020 may be used to track flight path, deployment of payloads, and/or interface with satellites in orbit (not shown). The secondary airship 2020 may also be used to power a spaceplane 2014.

The spaceplane 2014 has a heat exchanger that can use directed power for propulsion. The spaceplane returns safely to a designated area and/or an airport (not shown).

The secondary airship 2020 may be used as a temporary satellite, propellant depot, and as rendezvous spin stabilized systems in orbit to assemble larger spacecrafts (not shown).

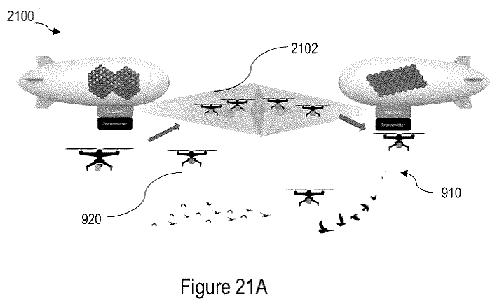

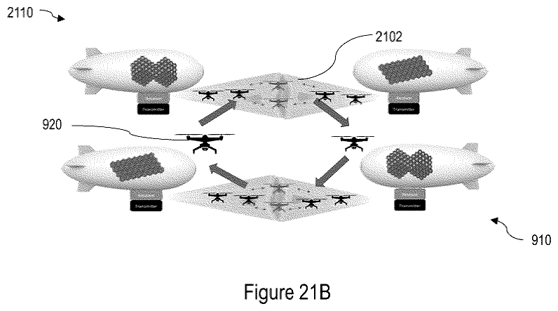

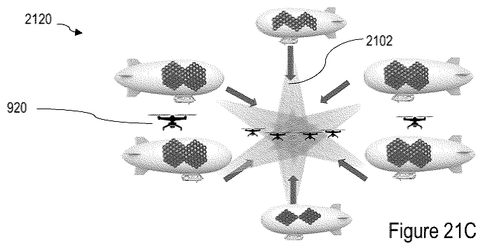

Referring now to FIGS. 21A, 21B, and 21C, shown therein are systems 2100, 2110, and 2120, respectively for transmitting beams 2102 between and among airships in an airborne fleet 910.

Referring to FIG. 21A, the beams 2102 are used for wildlife management.

Beam-riding aircraft 920 are used to keep birds away from beam-riding highways.

Referring to FIG. 21B, the beams 2102 are used to create a space-to-space, beam-riding highway.

Using the beams 2102 to transmit power wirelessly, beam-riding drones 920 can charge each other. Other drones 920 in the highway can also serve as power and data, hub, way point, and/or servicing stations.

Referring to FIG. 21C, shown therein are regulated beam-riding systems 2120 for over-the-air charging, command and control, beam-riding aircraft 920, and MW-powered aircraft.

In the systems 21A, 21B, and 21C, blockchain technologies may be used to record transactions of power and data transfer.

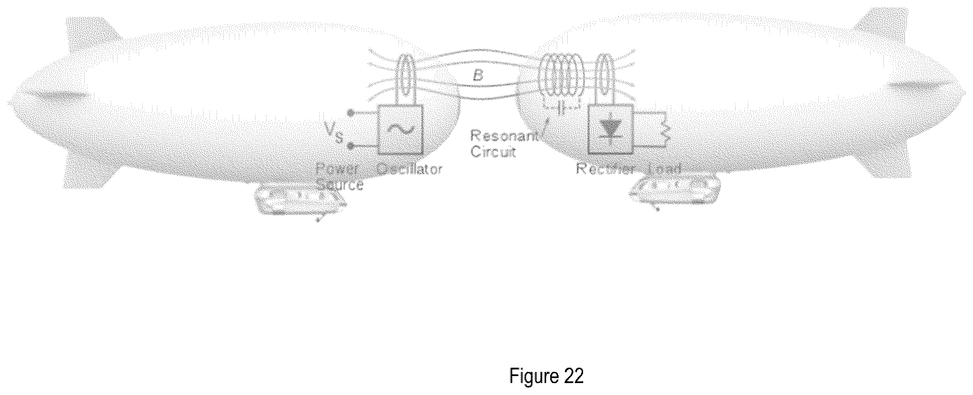

Referring now to FIG. 22, shown therein is a system for facilitating field-riding drones and highways therefor. The system uses inductive-coupled magnetic resonance.

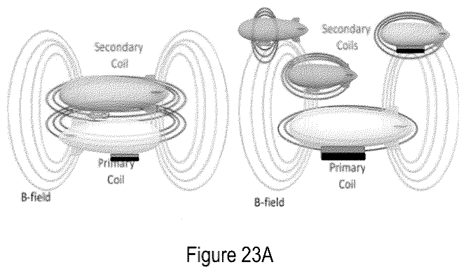

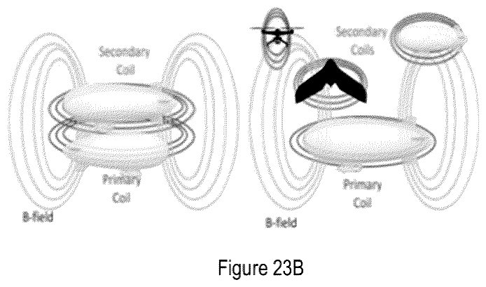

Referring now to FIGS. 23A and 23B, shown therein are a system for power transfer for charging an airborne fleet 910 and a method for management of power transfer in a mobile grid, respectively.

Referring to FIG. 23A in particular, inductive power transfer: depends on close proximity and significant portion of the primary coil B-fields intersecting the secondary coil. Resonant power transfer depends only on secondary coils intersecting a reasonable amount of primary coil flux lines.

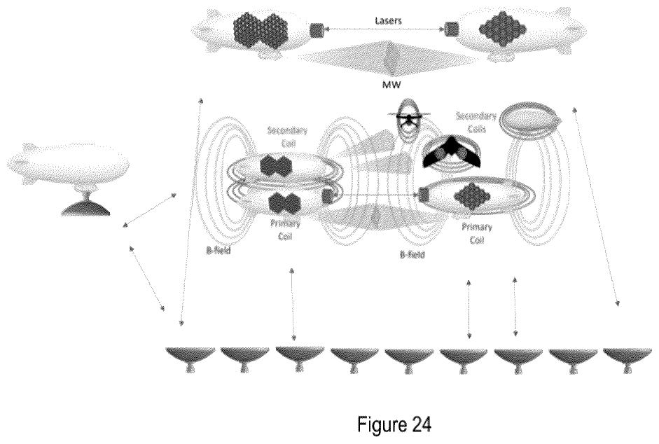

Referring to FIG. 24, shown therein is a system for hybrid wireless power transmission and network management.

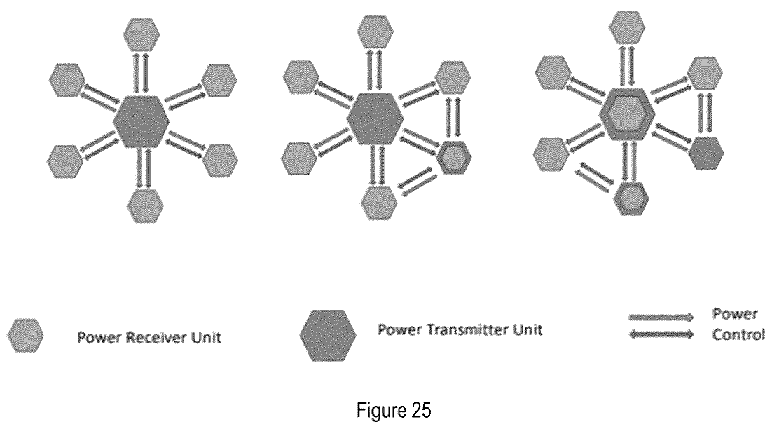

Referring now to FIG. 25, shown therein are relay stations for dynamic transfer of power and data.

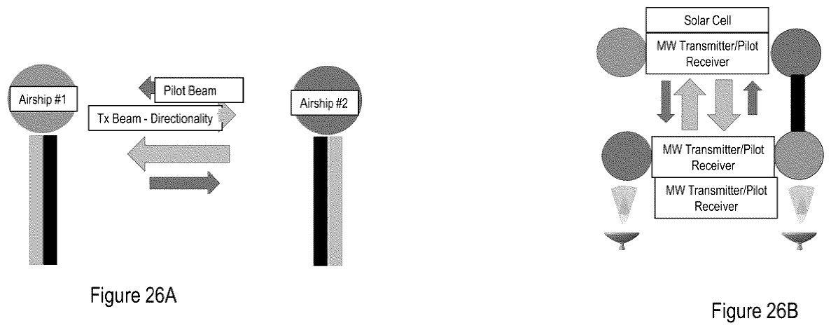

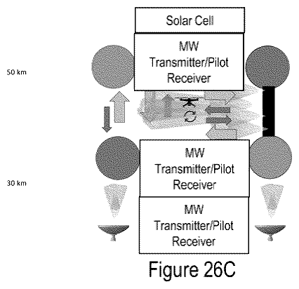

Referring now to FIGS. 26A, 26B, and 26C, shown therein are wide-beam area riding highways including point-to-point power transmission, point-to-point transportation including orbit raising and descending, and MW elevator including horizontal and vertical travel.

Referring to FIG. 26A in particular, autonomous and semi-autonomous swarms move at a designated speed. Autonomous and semi-autonomous swarms can recharge in transit. Power and data transfer may be recorded as a transaction using blockchain technologies between mobile nodes.

Referring to FIG. 26B in particular, point-to-point transmission may include the use of tethered systems in a hybrid approach.

Referring to FIG. 26C in particular, use of an MW elevator may include the use of tethered systems in a hybrid approach.

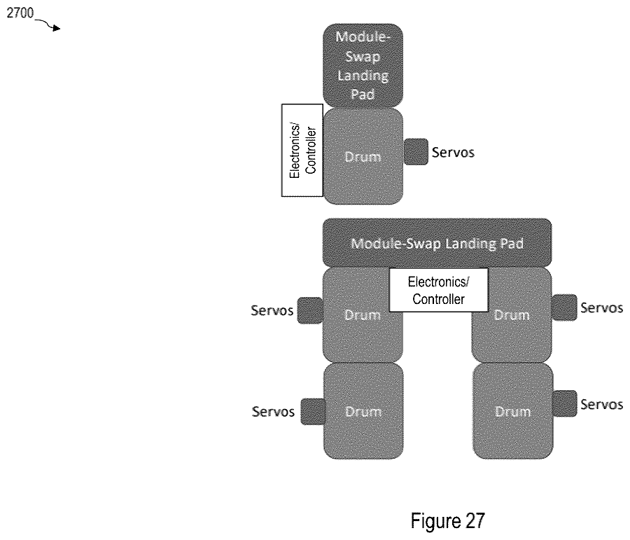

Referring now to FIG. 27, shown therein is a system 2700 for effecting modular swapping.

A module may be a fuel source, such as batteries, capacitors/super-capacitors, inductors/super-inductors, incendiary material, and reactive metal compounds or the like. Modules may also include structures of rectennas, coils, capacitors and/or solar cells to receive electromagnetic energy or the like.

In the system 2700, electronics and on-board computing and data storage modules may be swapped for maintenance and/or processing purposes.

Not shown in FIG. 27 is further functionality for in-flight modular swapping in various microgravity on Earth and in-space. A plurality of daughter drones may rendezvous with a mothership to change modules. Modules may be changed according to a maintenance schedule with autonomous and semi-autonomous operations.

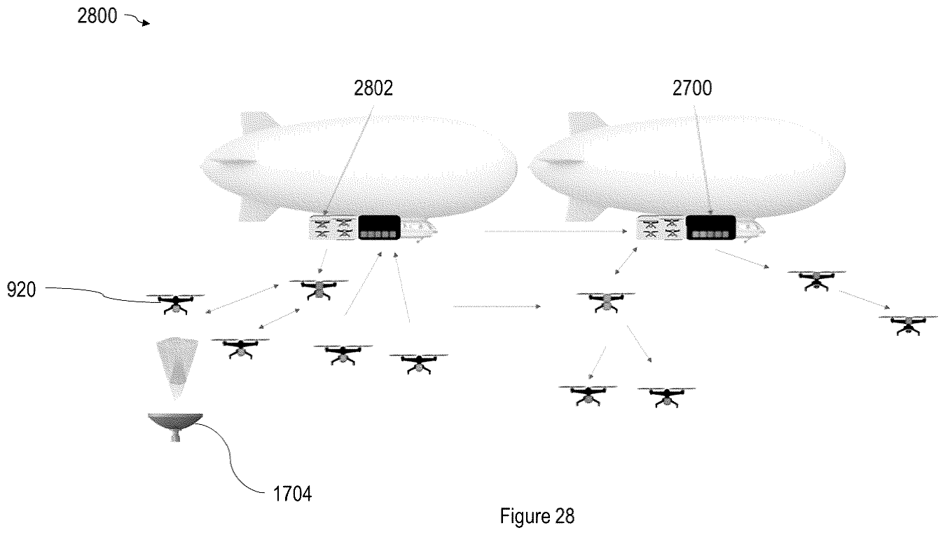

Referring now to FIG. 28, shown therein is a system 2800 for in-flight charging of the airborne fleet 910 of FIG. 9.

The system 2800 includes a drone deployer 2802 and a battery-swapping system 2700 as in FIG. 27 for facilitating wireless power transfer.

Drones may be recharged via wireless power transfer and/or return to the airship to be recharged on board.

The systems further provide functionality for in-flight rendezvous, module swapping and/or return to service.

Wireless power transfer can be used to recycle fuel to be reused. Transmitters may be fixed and/or mobile.

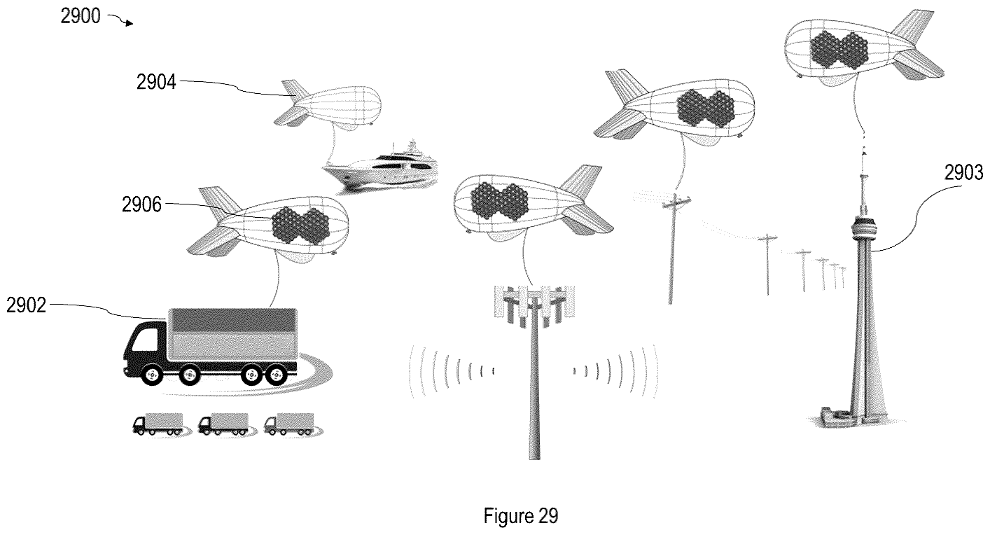

Referring now to FIG. 29, shown therein is a hybrid system 2900, including tethering, for power and data supply and distribution.

The hybrid system of 2900 includes vehicles 2902, such as boats, cars, trains, utility poles, radio-towers, etc. for providing a ground-based power supply.

The hybrid system 2900 further includes grounded power sources 2903, such as utility poles and other towers.

The hybrid system 2900 further includes an airship transportation unit 2904 with a fixed system 2906 (storage for power and data).

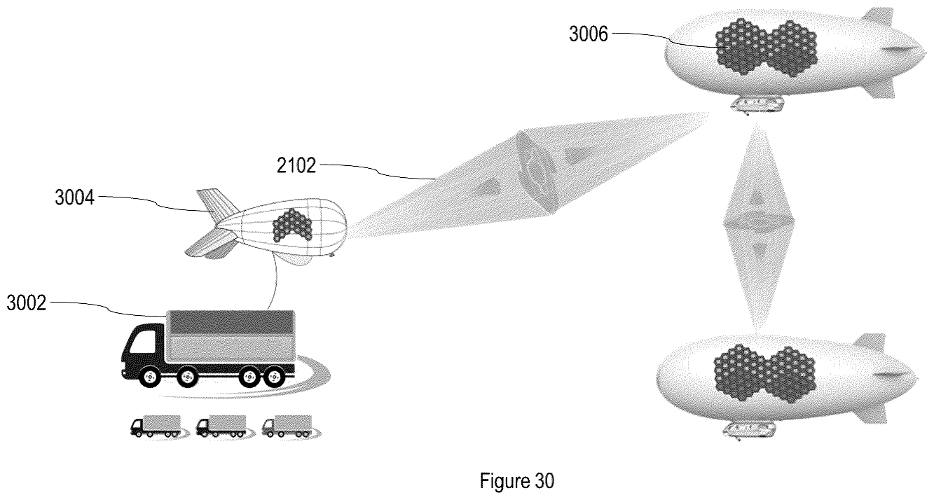

Referring now to FIG. 30, shown therein is a hybrid network 3000 for power and data supply and distribution.

The hybrid network 3000 includes a ground-based power supply 3002.

The hybrid network of FIG. 30 further includes an airship transportation unit 3004 with a fixed system 3006 (storage for power and data).

Power and data may be transmitted among airship transportation units 3004 via the beams 2102 of FIGS. 21A, 21B, and 21C.

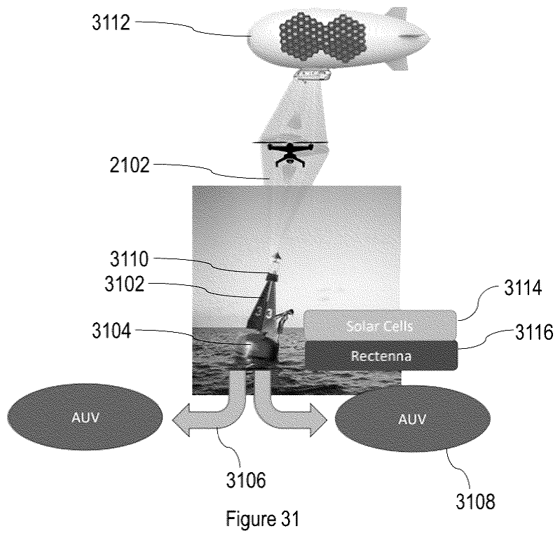

Referring now to FIG. 31, shown therein is an air-water system for power and data supply and distribution.

The air-water system includes a bouy 3102 with a receiver 3104 and cables 3106 underneath to connect to underwater systems and/or underwater drones (not shown) and a charging station 3110 whereby an airship 3112 creates a power and data link with the bouy 3102. The power and data link may include the beams 2102 of FIGS. 21A, 21B, and 21C.

The bouy has underwater architecture (not shown) to support charging of multiple autonomous underwater vehicles 3108.

In the air-water system, solar cells 3114 and rectennas 3116 may be rolled up and deployed.

Components of the air-water system and the entire air-water system 3100 itself may also be deployable, inflatable, and/or additively manufactured.

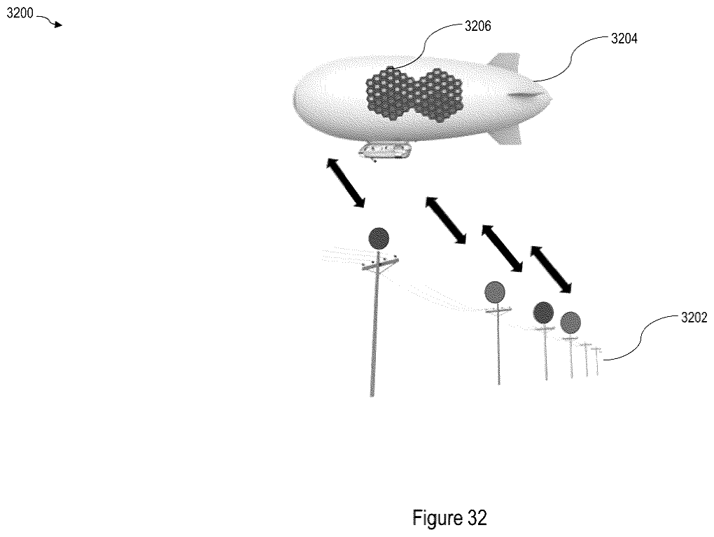

Referring now to FIG. 32, shown therein is a system 3200 for interfacing with infrastructure of a smart city, such as the smart city devices 112 of FIG. 1.

The system 3200 may create a mobile backhaul support for rapid response, create a network, and communicate with cellphones, computers, and devices on the ground

The system 3200 may use utility poles 3202 for receiving and transmitting power and data. The system 3200 may further use utility poles 3202 to tap into an existing distribution system.

The system 3200 may use communication towers (not shown), fixed nodes on buildings (not shown), and/or other free standing structures (not shown).

The system 3200 may further include in-situ monitoring sensors (not shown) and/or phased array communication systems (not shown).

The system 3200 further includes an airship transportation unit 3204 with a fixed system 3206 (storage for power and data).

An operator of the systems, methods, and devices described in the present disclosure may be located on Earth and/or in outer space. Such an operator may use 2D or 3D input devices. The systems, methods, and devices described in the present disclosure may relate to surface, sub-surface, and/or in-orbit operations.

An existing integrated VR and FlightGear system is unknown in the field(s). Moreover, an integrated portable GCS system for Beyond Visual Line of Sight (BVLOS) applications, particularly for long range and commercial applications is similarly heretofore unknown. Even where FPV goggles are commercially available, such as for racing applications and entertainment, such goggles are not capable of long-range operation. Consequently, the GCS system of the present disclosure may compensate for this gap in the field(s).

Dealing with ASVR-HMD may provide extensive R&D in VR systems leading to VR applications for aircraft in general and autonomous flight missions of UAVs in particular.

In some embodiments, a Commercial-off-the-shelf (COTS) stand-alone Virtual Reality (VR) headset may be connected to an aircraft simulation tool. The aircraft simulation tool may use FlightGear. The VR HMD may be used to visualize basic flight simulation via FlightGear for different air and space vehicles. Accordingly, firstly, position and orientation data from the stand-alone VR headset may be sent to the flight simulator. Secondly, using a radio transmitter, command inputs may be provided with an embedded code compatible with flight simulator software. Thirdly, a design of a flight deck may be performed and the integration of VR and FlightGear further accomplished using another embedded code.

A Commercial-off-the-shelf (COTS) stand-alone Virtual Reality (VR) headset may be connected to FlightGear (an aircraft simulation tool). The VR HMD may be used to visualize basic flight simulation via FlightGear for different air and space vehicles.

There may be an onboard camera integrated into the aircraft to provide real time actual flight visualization. The VR HMD may be used by pilots to accomplish actual flight testing of the aircraft via real time video input enabling First-Person View (FPV) operation.

The camera may replace a simulation view of the VR HMD setup and may be used in the context of real flight testing. Pilots may be able to remotely fly the aircraft and compare real flight test data and visuals with those of a simulation.

The camera system may capture images to integrate the Computer Vision Method (CVM) algorithms. CVM are used to process images for detection, obstacle avoidance, etc. CVM may allow for detecting phenomenon (obstacles, objects) newly introduced into an environment and may advantageously be used to introduce a new form of autonomous operations, such as landings and obstacle avoidance.

As part of CVM situational awareness provided to the pilot, the Ground Control Station (GCS) may account for Command and Control (C2) of the Aircraft. The CVM methods integrated into the camera may be an integral part of the GCS.

Pilots in commercial aviation have to land aircraft manually from time to time, due to established infrastructure such as airports. CVM may allow images and markers to be tracked and commands to be associated therewith. Thus, landing (the most dangerous flight phase, in some reports accounting for more than 50% of aerial accidents) can be performed autonomously. Obstacle detection for Detect and Avoid (DAA) can be established and conditions such as bird strikes mitigated.

To enhance the pilot's overall situational awareness of an individual aircraft and their fleet, a fleet tracking architecture is provided to allow the pilot operating a single aircraft to know where the aircraft is in relation to an entire fleet. The fleet tracking architecture may advantageously provide the operator with fleet management capabilities sufficient to monitor aircraft health and operating scenarios.

There may be provided an onboard camera which may be integrated to the aircraft. The VR HMD may be used by pilots to accomplish actual flight testing of the aircraft via real time video input enabling First-Person View (FPV) operation.

The camera may replace the simulation view of the VR HMD setup, and may be used in the context of real flight testing. Pilots may be able to remotely fly the aircraft and compare real flight test data and visuals with that of a simulation.

The camera system may capture images to integrate Computer Vision Method (CVM) algorithms. CVM may allow for detecting phenomena (obstacles, objects) newly introduced into an environment and may advantageously be used to introduce a new form of autonomous operations, such as landings and obstacle avoidance.

As part of the CVM situational awareness provided to the pilot, a Ground Control Station (GCS) may be developed to account for Command and Control (C2) of the Aircraft. The CVM methods integrated into the camera may be an integral part of the GCS.

To enhance the pilot's and a company's overall situational awareness of an individual aircraft and a fleet associated therewith, a fleet tracking architecture may be developed. The fleet tracking architecture may allow a pilot operating a single aircraft to know where the aircraft is in relation to the entire fleet. The fleet tracking architecture may provide the operator with fleet management capabilities sufficient to monitor aircraft health and operating scenarios.

A further focus of the present disclosure includes combining the view from actual flight tests to simulated flight tests, i.e., combining the view and data from sensors onboard a vehicle and simulated data, by providing the necessary symbology and data for the pilot to better understand performance and operations for validation with respect to the aircraft. This combination may advantageously achieve a single united system to combine all elements described in the present disclosure into a single visualization platform. Furthermore, different flight tests (e.g., level flight, phugoid mode, Dutch roll mode) may be used to validate the work of the new GCS equipped with the VR HMD setup. The development of a fleet management system may be tested. Simulated vs. real flight test data for all aircraft may be monitored and validated.

In an overall integration, improvement, expansion and testing of the foregoing objectives, a main focus may be towards combining the view from actual flight test to simulated flight test by providing the necessary symbology and data for the pilot to better understand aircraft performance and operations for validation. Such combination may be effected by simulating an environment online, with all the physics of the Earth, including drag profiles in the atmosphere, a gravity model, thermal, etc. so that performance in the simulated environment is corroborated with actual flight data and tests. Furthermore, different flight tests (e.g., level flight, phugoid mode, Dutch roll mode) may be used to validate the new GCS equipped with the VR HMD setup. Development of a fleet management system may be tested. Simulated vs. real flight test data for all aircraft can be monitored and validated.

Position and orientation data from a stand-alone VR headset may be sent to a flight simulator (FlightGear) via Extensible Markup Language (XML) codes. Viewpoint control may accordingly be initiated. Secondly, command inputs may be provided using a radio transmitter (e.g., FrSky Taranis X9D) based on an embedded code compatible with FlightGear (XML code). Research, development, and evaluation of multiple flight deck prototypes may require a system that allows for fast deployment and evaluation. FlightGear, with a VR headset, is an exceptional method of conducting virtual flight testing, drastically reducing cost and time commitments. The corresponding flight deck design may be accomplished using an integrated graphical interface provided by AC3D software, and the input commands may be defined by XML codes for different functions. Finally, integration of VR and FlightGear may be performed. The integration may use another embedded code in XML format. There is also functionality for stereoscopic viewing built into FlightGear. There are at least two approaches that may be used:

Integration of the VR headset with the FlightGear simulation's graphic engine, for which there are multiple channels from which views may be coordinated, for pilot viewing comfort.

Methods of transport design are different to fixed wing aircraft and may involve showing information and formats differently in a flight deck. Open Source HMI software such as CorelDraw/JavaScript may advantageously be utilized to prototype flight displays for the operations conducted by different air and space vehicles.

An important aspect hereof is constant pilot feedback on the integration and improvement in flight testing scenarios and timing. A larger number of scenarios and concepts may be tested using simulation. Accordingly, different flight tests (e.g., level flight, phugoid mode, Dutch roll mode) may be performed to ensure the work of the new flight simulator is in accordance with the available flight tests and experimental results provided.

The Mission Control System (MCS) may use an onboard camera on the aircraft to provide real-time actual flight visualization. The MCS may include two screens, one for the GCS Software (e.g., Presagis) and the other one for the FPV stream. The MCS provides the operator with all necessary information to perform duties without missing information or increased workload and stress. The operator can monitor all flight related data, for example, True and Indicated Airspeed, Ground Speed, Plane position, Virtual Horizon, Fuel and battery status, Direction, AItitude, and Wind Speed and direction.

The position and orientation data of the onboard camera and flight are sent to the GCS software in the VR headset along with real time video input providing FPV. This may initiate viewpoint control.

Commanding the inputs using the same radio transmitter (e.g., FrSky Taranis X9D) may be addressed based on an embedded code compatible with GCS software (e.g., via VAPS XT).

The designed flight deck may be adapted to function with the GCS software. Operating GCS software using VR headsets can be an effective method of conducting flight missions.

Autonomous operation may be performed using CVM algorithms by tracking and markers that are associated with command structures. Automated operations can be used to solve major operation issues such as landing and obstacle detection. Obstacle and object detection may also be performed using CVM, allowing the tracking of obstacles and objects in the aircraft flight path to Detect and Avoid (DAA) and recognizing their size, orientation, and motion using necessary algorithms.

Finally, fleet tracking architecture may be developed to enhance overall situational awareness of the pilot and the operator of a fleet of aircraft. Complete asset tracking and Command and Control (C2) capabilities may be integrated to support operations of the entire fleet of aircraft. Such a system may provide advanced situational awareness capabilities, minimize accidents, and enhance operational capabilities. This system may act as an Autonomous Virtual Air Traffic Control/Management (AV-ATC/M).

Constant pilot feedback on the integration and improvement in flight scenarios and timing is expected to ensure validity of the project.

Overall integration, improvement, expansion, and testing may be conducted. Combining the view from real-flight test to simulated flight test by providing necessary symbology and data for the pilot to better understand performance and operations of the aircraft for validation may be performed. Such combination may be effected by simulating an environment online, with all the physics of the Earth, including drag profiles in the atmosphere, a gravity model, thermal, etc. so that performance in the simulated environment is corroborated with actual flight data and tests. Fleet management testing may also be performed. Herein, different flight tests (e.g., level flight, phugoid mode, Dutch roll mode, pull down, pull up) may be implemented to validate the work of the new GCS equipped with the VR HMD setup, which has the capability of performing autonomous flight via the AV-ATC/M tool. Simulated versus. real flight test data for all aircraft can be monitored and validated. Pilot tests and feedback may also be performed to ensure compatibility of the design with human factors as well.

Software development may be implemented on the stand-alone VR headset, radio transmitter setup, flight deck design, interface code, and experimental tests. The Ground Control Station (GCS) software setup may be developed on the VR HMD, and the design may be continued by the radio transmitter setup, design of the flight deck, and autonomous operation setup using CVM algorithms. Thereafter, the GCS development may be continued alongside fleet tracking architecture and pilot feedback. Moreover, a technical report may be provided. The new GCS system and fleet management system may be tested by operators and pilots. Based on feedback, the design may be modified to meet requirements provided. Finally, the technical report may be provided and the operators and pilots trained to practically use the proposed HMD device.

The present disclosure includes VR HMD developed for flight simulations tests, GCS equipped with the VR HMD, and enhanced ground control station equipped with the VR headset.

These deliverables are described in detail as following. The stand-alone VR with test pilots may be utilized to accomplish a sizeable portion of flight tests in a simulation environment in addition to ongoing real flight tests. Accordingly, a flight test process may advantageously be sped up using the simulated environment and may advantageously decrease a budget required for the real time flight testing.

Real flight tests may further be accomplished with the GCS equipped with the VR HMD. The VR HMD may have the capability of running actual flights in addition to a simulated flight.

A cycle may further be achieved from simulated training to real flight with one integrated VR HMD tool to manage a fleet of products at the time of project completion. Furthermore, the GCS package equipped with the stand-alone VR headset may be a commercially available product. Consequently, an enhanced ground control station equipped with the advanced stand-alone virtual reality headset may be provided.

The stand-alone VR with test pilots may be utilized to accomplish a sizeable portion of the flight tests in the simulation environment in addition to the ongoing real flight tests. Accordingly, the flight test process may be sped up and the budget required for real time flight testing decreased. Real flight tests may further be accomplished with the new VR HMD. Finally, a cycle may be achieved from simulated training to real flight with one integrated VR HMD tool to manage a fleet of products at the time of project completion. Furthermore, the new GCS package equipped with the stand-alone VR headset may be commercially available.

The present disclosure as herein disclosed may facilitate a unique training and research asset for application to test HMI, workload, and situational awareness methods. With the successful development of an enhanced portable ground control station equipped with an advanced stand-alone virtual reality head-mounted display for flight testing and evaluations, there may be provided a greater training tool to flight test engineers and new pilots who are concerned with testing new avionics with rapidly evolving technology. Training the flight test engineers and test pilots of tomorrow is a critical aspect of advancing the aerospace field in advanced flight testing, training and simulation.

VR setups are generally small and portable. VR setups may thus be a suitable for training and operating pilots in remote locations, which can also enable sustainable air operations for training and operation. Determination of suitability for desired mission tasks is subject to test crews. Such specialists may require training in a realistic environment on new aircraft types with the latest avionics. Such a research and development project makes great strides for custom development and avionics training, thereby propelling Canada to be a leader in the field of simulation and advanced flight training. There is a collective movement in using Remotely Piloted Aircraft Systems (RPAS) throughout the world for delivery, emergency services, and other uses. Producing such technology that provides a capability for advanced situational awareness and developing remote aircraft for the Canadian and world markets represents a significant step forward and improvement over existing technologies.

A user of the systems, methods, and devices as herein disclosed may use one or more input devices, including but not limited to gloves, a body suit, a remote control, and other 2D and/or 3D input devices. The gloves of the systems, methods, and devices as herein disclosed provide haptic feedback to the user to monitor and evaluate applications.

The system, method, and device as herein disclosed may further include an alert-based subsystem to augment an operator's capabilities and reduce the workflow of the operator. By incorporating AI/ML, some operator tasks may be automated. Advantageously, the operator may thus be able to accomplish more.

The system, method, and device as herein disclosed may further include a sensor-based subsystem for incorporating any of high-resolution cameras, pressure sensors, lidar, mechanical, and thermal systems or the like.

The system, method, and device as herein disclosed may further provide the ability to control, manipulate, and receive feedback from 2D/3D space.

The system, method, and device as herein disclosed may further include the ability to change from controlling one mobile device to controlling another mobile device.

The system, method, and device as herein disclosed may use graspable, wearable, and/or touchable subsystems for real-time operations. The system, method, and device as herein disclosed may incorporate built-in pre-determined functionality. In the system, method, and device as herein disclosed machine learning and AI may be added to augment operator skills for real time uses, monitoring, and evaluation for operator training purposes.

In an embodiment, the system, method, and device as herein disclosed may provide data management and data networks whereby a mobile device collects data and transmits it throughout the system.

In an aspect, the control station may be portable.

In an aspect, there may be provided end-to-end control in the system, method, and device as herein disclosed.

The present disclosure as herein disclosed may enable the following use cases and applications: real-time applications and operations; emergency network; search and rescue; disaster management; back-up network for emergency communications; mobile backhaul services; fire prevention and management; in-situ monitoring and data collection from Internet of Things (“IOT”) sensors; tracking and monitoring of rockets and/or other hypersonics; surveying using photorealistic graphics; supporting airport services for tracking and managing of mobile systems (airplanes, drones, airships, etc.); beyond line of sight operations; and land and resource utilization, climate change, and environmental assessment.

The present disclosure as herein disclosed may further enable in-space applications in the context of relay and servicing networks, including, for example:

Inflatable and deployable systems, directing power and data for control of in-space systems, constellation of satellites for in-orbit and surface operations of Moon bases, rovers, drones, sensors, exploration vehicles, and other space based structures, including space architecture, and Moon, Mars, and free-space structures.

While the above description provides examples of one or more apparatus, methods, or systems, it will be appreciated that other apparatus, methods, or systems may be within the scope of the claims as interpreted by one of skill in the art.

1. A system for remote control of a mobile device, the system comprising:
a primary receiver for providing primary command and control of the mobile device;
a secondary receiver for providing secondary command and control of the mobile device;
the mobile device configured to respond to command and control signals sent by any of the primary receiver and the secondary receiver; and
a relay platform for relaying the command and control signals throughout the system.

2. The system of claim 1, wherein the primary receiver comprises a training module for training using actual fight data and simulated flight data fed through the primary receiver.

3. The system of claim 1, wherein the mobile device is any one of a vehicle, a robot, a land vehicle, a car, a truck, a water vehicle, a boat, a submarine, an air vehicle, an airplane, an airship, a helicopter, a drone, a space vehicle, a satellite, and a rocket.

4. (canceled)

5. The system of claim 1, wherein the mobile device comprises a computer-readable storage medium storing and processing computer vision method algorithms for detecting obstacles and objects.

6. The system of claim 1, wherein the computer vision method algorithms comprise machine learning and artificial intelligence techniques.

7. The system of claim 1, wherein the primary receiver comprises an extended reality headset.

8. The system of claim 7, wherein the mobile device is configured to provide data and camera feed to the extended reality headset.

9. The system of claim 1, wherein the secondary receiver comprises haptic controls.

10. (canceled)

11. (canceled)

12. The system of claim 1, wherein the relay platform is a high-altitude relay platform stationed above Earth.

13. The system of claim 1, wherein the mobile device comprises a robotic arm suitable for grasping, manipulating, and moving objects.

14. The system of claim 1, further comprising a fleet tracking architecture component for determining where the mobile device is in relation to other mobile devices.

15. The system of claim 14, wherein the system comprises an autonomous virtual air traffic control and management system through the fleet tracking architecture component.

16. The system of claim 1, further comprising a second mobile device, wherein the mobile device and the second mobile device are in communication with each other, and wherein the mobile device and the second mobile device are each in communication with the relay platform and the primary and secondary receivers.

17. (canceled)

18. The system of claim 1, further comprising a sensor-based subsystem for incorporating any of high-resolution cameras, pressure sensors, lidar, mechanical, and thermal systems.

19. The system of claim 16, wherein the primary and secondary receivers are each configured to switch from providing command and control of the mobile device to providing command and control of the second mobile device.

20. The system of claim 1, further comprising a data collection subsystem for collecting data, a distributed data processing pipeline for analyzing the data, and a visualization subsystem for data management and pilot training.

21. (canceled)

22. (canceled)

23. A method for remote control of a mobile device, the method comprising:
generating primary command and control signals at a primary receiver;
generating secondary command and control signals at a secondary receiver for supplementing the primary command and control signals;
relaying the primary and secondary command and control signals through a relay platform to the mobile device;
receiving the primary and secondary command and control signals at the mobile device; and
operating the mobile device remotely according to the primary and secondary command and control signals.

24-32. (canceled)

33. The method of claim 23, further comprising performing the relaying, receiving, and operating steps for at least one additional mobile device.

34. (canceled)

35. The method of claim 23, wherein the relay platform operates at an altitude from 3 kilometres to 22 kilometres.

36. (canceled)

37. The method of claim 36, further comprising collecting and transmitting the data by the mobile device.
